(19) United States
(12) Patent Application Publication
(10) Pub. No.: US 2013/0171461 A1
(43) Pub. Date: Jul. 4, 2013

(54) METHODS FOR SYNTHESIS OF POLYMACROMOLECULES AND POLYMACROMOLECULAR BRUSHES

(71) Applicants: Benjamin I. Dach, New York, NY (US); Jeffrey T. Koberstein, Storrs, CT (US); Sandra Turro, Tenafly, NJ (US)

(72) Inventors: Benjamin I. Dach, New York, NY (US); Jeffrey T. Koberstein, Storrs, CT (US); Nicholas J. Turro, Tenafly, NJ (US)

(73) Assignee: THE TRUSTEES OF COLUMBIA UNIVERSITY IN THE CITY OF NEW YORK, New York, NY (US)

(21) Appl. No.: 13/572,963

(22) Filed: Aug. 13, 2012

Related U.S. Application Data
(60) Provisional application No. 61/522,370, filed on Aug. 11, 2011.

(51) Int. Cl. B05D 1/36; B32B 27/08; C08F 120/10

(52) U.S. Cl. CPC B05D 1/36; C08F 120/10; B32B 27/08
USPC 428/520; 525/275; 427/407.1; 427/532; 427/409; 427/407.2

(57) ABSTRACT

In one aspect, the present invention is directed to methods for fabricating multilayer polymacromer compositions. In some embodiments, the multilayer polymacromer compositions described herein can comprise heterobifunctional macromolecules and heterotrifunctional molecules.

This application claims priority to U.S. Provisional Application No. 61/522,370, filed Aug. 11, 2011, the entire contents of which is incorporated herein by reference.

This application is related to International Patent Application Ser. No. PCT/US2009/063282, published as WO 2010/053993; and U.S. Provisional Patent Application Ser. No. 61/467,573 filed Mar. 25, 2011, the disclosure of all of which is hereby incorporated by reference in its entirety for all purposes.

This invention was made with government support under grants IGERT 02-21589 and DMR-07-04054 awarded by the National Science Foundation; W911NF-04-1-0282, W911NF-10-1-0184, and W911NF-11-0372 awarded by the U.S. Army Research Laboratory and the U.S. Army Research Office; and P50 HG002806 awarded by the NIH. The government has certain rights in the invention.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

All publications, patent applications, patents, and other references mentioned herein are incorporated by reference in their entirety. The patent and scientific literature referred to herein establishes knowledge that is available to those skilled in the art. The issued patents, applications, and other publications that are cited herein are hereby incorporated by reference to the same extent as if each was specifically and individually indicated to be incorporated by reference. In the case of inconsistencies, the present disclosure will prevail.

### BACKGROUND OF THE INVENTION

Solid phase synthesis (SPS) is a method by which molecules are bound to a solid surface (commonly a bead) and then synthesized step-by-step in a reactant solution. Merrifield is accredited with discovering this method for peptides (J. Am. Chem. Soc. 1963, 85, 2149; hereby incorporated by reference in its entirety) and Letsinger is known to be the founder of solid phase DNA Synthesis (J. Am. Chem. Soc. 1964, 86, 5163-5165; hereby incorporated by reference in its entirety). Compared to conventional solution phase synthesis, it is easier to remove excess reactant and by-products because the desired product is covalently bound to the solid surface. SPS is a modular method that generally employs building blocks with two complementary functional groups, one of which is protected. The synthetic pathway is controlled by the order of addition (and subsequent deprotection) of these building blocks to a solid substrate that is modified to present unprotected surface functional groups. SPS has become an important method for the synthesis of peptides, DNA and other biopolymers for which a certain non-symmetric predetermined sequence is desirable, and has also been employed recently in combinatorial chemistry (See, for example, J. Am. Chem. Soc. 1963, 85, 2149; J. Org. Chem. 2009, 74, 8476-9; Bioconjugate Chem. 2001, 12, 346-353; J. Am. Chem. Soc. 1964, 86, 5163-5165; Anal. Chem. 2010, 82, 3556-66; Science 1991, 251, 767-773; Proc. Natl. Acad. Sci. 1994, 91, 5022-5026; Nat. Biotechnol. 1999, 17, 974-978; Biomacromolecules. 2006, 7, 1239-44; Science 2000, 289, 1760-1763; Biomacromolecules 2007, 8, 1775-1789; Comb. Chem. 2004, 7, 547-556; and J. Am. Chem. Soc. 2004, 126, 3472-6; each of which hereby incorporated by reference in its entirety).

One important drawback of SPS is that it often requires the use of harsh reagents to release the synthesized product from the solid support. These reagents can potentially degrade the synthesized product. Thus, there is a need for new methods to perform SPS that allow cleavage of a resultant polymer from the surface using mild conditions.

Polymer brushes have been prepared on surfaces, for example, via a layer-by-layer approach that comprises iterative click chemistry reactions (WO 10/053,993; hereby incorporated by reference in its entirety). However, incorporation of a photocleavable moiety between the polymer brush and the surface, or removal of the polymer brush from a surface without adversely affecting the polymer are not described.

### SUMMARY OF THE INVENTION

In one aspect, the methods described herein relate to a method for generating a multilayer polymacromer composition, the method comprising: (a) functionalizing a substrate with a primer surface group to form a functionalized substrate layer, (b) covalently linking a linker to the primer surface group, wherein the linker comprises a photocleavable functionality and a click moiety terminus, (c) forming a monomolecular layer by contacting the click moiety terminus of the linker with a first heterobifunctional macromolecule comprising a polymer backbone, a first click moiety terminus and a protected second click moiety terminus, (d) deprotecting the protected second click moiety terminus to form a functionalized monomolecular layer, and (e) forming a second monomolecular layer by contacting the functionalized monomolecular layer with a second heterobifunctional macromolecule comprising a polymer backbone, a first click moiety terminus and a protected second click moiety terminus, or a first heterotrifunctional branch comprising a first click moiety group and at least two protected second click moiety groups. In some embodiments, the method further comprises repeating steps (c) to (e) until a multilayer polymacromer composition having (i) a primer surface layer further comprising a linker, wherein the linker comprises a photocleavable functionality, (ii) a monomolecular layer comprising a heterobifunctional macromolecule, and (iii) a desired number of monomolecular layers between the linker and surface monolayer is obtained. In some embodiments, the methods further comprise the step of removing the multilayer polymacromer composition from the substrate, wherein removal is achieved by irradiation of the photocleavable functionality.

In another aspect, the compositions described herein relate to a multilayer polymacromer composition comprising (a) a first terminus comprising a nitrophenyl functionality, and (b) n-layers, wherein each layer comprises a heterobifunctional macromolecule or a heterotrifunctional branch, and wherein n is an integer between 1 and 100.

In some embodiments, the polymacromer composition comprises one or more layers of heterobifunctional macromolecules. In some embodiments, the polymacromer composition comprises a dendrimer or dendrimeric structure.

In some embodiments, the first click moiety is an azide group and the protected second click moiety is a silyl alkyne group.

In some embodiments, the branch is comprised of a plurality of protected second click moiety groups.

In some embodiments, the first click moiety group of the heterotrifunctional branch is a an azide group and at least two protected second click moiety groups of the heterotrifunctional branch are silyl alkyne groups.

In some embodiments, the first click moiety is an alkyne group and the second click moiety is an azide group.

In some embodiments, the first click moiety group of the heterotrifunctional branch is an alkyne group and at least two second click moiety groups of the heterotrifunctional molecule are azide groups.

In some embodiments, the composition has n-layers, wherein n is an integer from 1-100.

In some embodiments, the macromolecule is comprised of a polymer.

In some embodiments, the macromolecule is comprised of a polymer unit of about 10-500 Daltons.

In some embodiments, the macromolecule is comprised of a silyl-alkyne-PS-N₃, silyl-alkyne-PtBA-N₃, silyl-alkyne-PnBA-N₃, or silyl-alkyne-PMMA-N₃ polymer.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1. Exemplary schematic description of the solid phase synthesis of a four-step polymacromer on a silicon wafer and isolation of the product by subsequent photocleavage (primer layer is between SiO₂ surface and NBOC layer, NBOC═NBOC photocleavable linker).

FIG. 2. Exemplary embodiments of (1) a primer, (2) a linker (NBOC photocleavable linker to M₁), (3) a macromonomer (PtBA), and (4) a photocleaved polymacromer composition [PtBA polymacromer (M₁-M₂-M₃-M₄)].

FIG. 3. Exemplary illustrations of heterotrifunctional branch molecules in accordance with certain embodiments of the invention described herein.

FIG. 4. Exemplary reaction scheme for solid phase synthesis of a PtBA PM on a SiO₂ surface followed by photochemical cleavage of the product from the surface.

FIG. 5. ¹H NMR (400 MHz) for compound 1.

FIG. 6. ESI-MS positive for NBOC (compound 2).

FIG. 7: ¹H NMR (400 MHz) for NBOC (compound 2).

FIG. 8: XPS spectra of bare silica, silica-amine, silica-NBOC, silica-PtBA4, and silica substrate after photocleavage.

FIG. 9: C is XPS spectrum of silicon oxide wafer, silica-AHAMTES, silicon-NBOC, silica-P4, and photocleaved silicon-NCOOH. Take off angle was 15° and X-ray sampling depth was 2.4 nm.

FIG. 10: N is XPS spectrum of silicon oxide wafer, silica-AHAMTES, silicon-NBOC, silica-P4, and photocleaved silicon-NCOOH. Take off angle was 15° and X-ray sampling depth was 2.4 nm.

FIG. 11: O 1s XPS spectrum of silicon oxide wafer, silica-AHAMTES, silicon-NBOC, silica-P4, and photocleaved silicon-NCOOH. Take off angle was 15° and X-ray sampling depth was 2.4 nm.

FIG. 12: Si 2p³ XPS spectrum of silicon oxide wafer, silica-AHAMTES, silicon-NBOC, silica-P4, and photocleaved silicon-NCOOH. Take off angle was 15° and X-ray sampling depth was 2.4 nm.

FIG. 13: % C/% Si atomic composition ratios from multiplex XPS spectra of silicon oxide wafer, silica-AHAMTES, silicon-NBOC, silicon-P1, silicon-P2, silicon-P3, silicon-P4, and photocleaved silicon-NCOOH. Take off angle was 15° and X-ray sampling depth was 2.4 nm.

FIG. 14: Control Water Contact Angle (WCA) Measurements: “Clicking” PtBA without deprotecting the TMS group first. The WCA did not change as P2 layered the surface, since the preceding layer was not deprotected and P2 did not covalently bind to P1. The layers of P2, P3, and P4 were washed away.

FIG. 15: Control Ellipsometry Measurements: Measured (filled squares) and theoretical (open circles) film thickness (nm) from ellipsometric measurements. The ellipsometric data indicates that P1 was not deprotected and no new layers of polymer covalently bind to the surface. The layers of P2, P3, and P4 were washed away and were not covalently attached.

FIG. 16: WCA measurements on bare, amine, NBOC, 1 PtBA macromonomer, 2 PtBA macromonomers, 3 PtBA macromonomers, 4 PtBA macromonomers, and photocleaved substrates (point on far right).

FIG. 17: Ellipsometry Measurements: Measured (filled squares) and theoretical (open circles) film thickness (nm) from ellipsometric measurements for bare silicon oxide, AHAMTES, NBOC, PtBA1, PtBA2, PtBA3, PtBA4, and photocleaved substrates (point on far right).

FIG. 18: AFM images for (a) SiO₂, RMS=0.143 nm, (b) AHAMTES, RMS=0.870 nm, (c) NBOC, RMS=2.54 nm, (d) PtBA1, RMS=0.488 nm, (e) PtBA2, RMS=0.586 nm, (f) PtBA3, RMS=0.453 nm, (g) PtBA4, RMS=0.219 nm, and (h) Photocleaved substrate, RMS=1.30 nm.

FIG. 19: Line graph for AFM image of photocleaved surface. Indicates the height of each island was about 2 nm, which is about the size of the end-to-end length of the NBOC molecule.

FIG. 20. GPC traces of PtBA homopolymacromers produced by photocleavage after SPS: a) M₁, b) M₁-M₂, c) M₁-M₂-M₃, and d) M₁-M₂-M₃-M₄. The dotted line is the GPC trace of the original PtBA macromonomer.

FIG. 21. GPC traces of PtBA homopolymacromers produced by photocleavage after SPS. Scaled to 4 wafers per GPC trace: a) M₁, b) M₁-M₂, c) M₁-M₂-M₃, and d) M₁-M₂-M₃-M₄. The dotted line is the GPC trace of the original PtBA macromonomer.

FIG. 22. Structure of A) α-TMS-alkyne-β-azide-poly(tert-butyl acrylate), B) α-TMSalkyne-β-azide-poly(polystyrene) and C) α-TMS-alkyne-β-azide-poly(methyl methacrylate).

FIG. 23. Structure of a representative alkyne-functional silane.

FIG. 24. A) Deconvolution results for the XPS high resolution C1s spectrum of first layer of PS after click chemistry showing the contribution of carbon and the π*-π shakeup satellite (TOA=15°). B) Deconvolution results for the XPS high resolution C1s spectrum of first layer of PtBA after click chemistry showing the contribution of each carbon type (TOA=15°).

FIG. 25. Deconvolution results for the XPS high resolution C1s spectrum of first layer of PS and second PtBA and third PS after click chemistry showing the contribution of each carbon type (TOA=15°).

FIG. 26. Control experiment surface layer of PtBA-TMS on black and on red reacted with N₃-PS-TMS. This figure shows that the protecting group TMS on PtBA is stable on the surface after heating for 18 hrs and no reaction occurred.

FIG. 27. XRR profiles and fits of the bare, amine, NBOC, 1 PtBA macromonomer, 2 PtBA macromonomers, 3 PtBA macromonomers, 4 PtBA macromonomers, and photocleaved substrates.

FIG. 28. Ellipsometric thicknesses for SPS films prepared from TMSalkyne-PS-N₃. The dashed line shows predictions for complete conversion based upon the areal density of the brush comprising one macromonomer layer, and the dotted line shows predictions based upon the areal density of brushes comprising two macromonomers.

FIG. 29. Ellipsometric thicknesses for SPS films prepared from TMSalkyne-PtBA-N₃.

FIG. 30. Brush growth for macromonomers of different size. A) larger polymer deposited as first layer, all layers have equal areal density. B) smaller polymer deposited as first layer, first layer has different areal density, 2^{nd} through n^{th} layers have same areal density.

FIG. 31. XPS high-resolution C is spectra of base polymer controls (A, B) and brushes (C-E) (15° takeoff angle).

FIG. 32. Ethylene glycol contact angles for copolymacromer brushes consisting of alternating TMS-alkyne-PS-N₃ (additions 1 and 3) and TMS-alkyne-PtBA-N₃ (additions 2 and 4) macromonomers. The dashed lines indicate the contact angles for pure PtBA and PS, respectively.

FIG. 33. Ellipsometric thicknesses for alternating copolymacromer brushes: TMS-alkyne-PS-N₃ (additions 1 and 3) and TMS-alkyne-PtBA-N₃ (additions 2 and 4). The dashed line shows predictions based upon the areal density of functional groups in the first PS brush; the solid line is the prediction based upon the areal density after addition of the first PtBA macromonomer.

FIG. 34. Ellipsometric thicknesses for alternating copolymacromer brushes: TMS-alkyne-PMMA-N₃ (additions 1 and 3) and TMSalkyne-PS-N₃ (additions 2 and 4). The dashed line shows predictions based upon the areal density of functional groups after addition of the first macromonomer, and the solid line is the prediction based upon the areal density of functional groups after addition of the second macromonomer.

### DETAILED DESCRIPTION OF THE INVENTION

Described herein are methods and compositions useful for the preparation of multilayer polymacromeric compositions that may be removed from a substrate surface by irradiation. In some embodiments, the methods described herein can be used to prepare covalently bonded multilayers or polymacromeric compositions by solid phase synthesis. In some embodiments, the methods described herein can be used to prepare dendrimers or dendrimeric compositions by solid phase synthesis. In some embodiments, the methods and compositions described herein comprise at least one heterobifunctional macromolecule or at least one heterotrifunctional molecule. The thickness of one or more monomolecular layers or polymacromer compositions may controlled and deposited in any desired sequence.

### DEFINITIONS

As used herein and in the appended claims, the singular forms “a,” “an,” and “the” include plural references unless the content clearly dictates otherwise.

The term “about” is used herein to mean approximately, in the region of, roughly, or around. When the term “about” is used in conjunction with a numerical range, it modifies that range by extending the boundaries above and below the numerical values set forth. The term “about” is used herein to modify a numerical value above and below the stated value by a variance of 20%.

As used herein, the term “click chemistry” refers to the use of chemical building blocks to drive a linkage reaction with appropriate complementary sites in other blocks. These chemical reactions (e.g., including, but not limited to, those between azide and alkyne groups) are specific and result in covalent linkage between the two molecules. Click chemistry can be used to drive selective modular, stereospecific coupling of molecules (Kolb, H. C., Finn, M. G., and Sharpless, K. B. Angew. Chem. Int. Ed. 2001, 40, 2004; Rostovtsev, V. V., Green, L. G., Fokin, V. V., Sharpless, K. B., Angew. Chem. Int. Ed. 2002, 41, 2596; Tornoe, C. W., Christensen, C., Meldal, M. J. Org. Chem. 2002, 67, 3057; Dondoni, A. Angew. Chem. Int. Ed. 2008, 47, 8995; each if which hereby incorporated by reference in its entirety). Click chemistry can also be used to modify surfaces and surface properties (Moses, J. E. and Moorhouse, A. D., Chem. Soc. Rev 2007, 1249-1262; WO 2010/053993; and U.S. Ser. No. 61/467,573; each of which hereby incorporated by reference in its entirety).

As used herein, the term “dendrimer” or “dendrimeric structure” refers to any poly-armed organic molecule, and can include dendrimers having defects in the branching structure, dendrimers having an incomplete degree of branching, crosslinked and uncrosslinked dendrimers, asymmetrically branched dendrimers, star polymers, highly branched polymers, highly branched copolymers and/or block copolymers of highly branched and not highly branched polymers. Examples of dendrimers include, but are not limited to poly(propyleneimine) (DAB) dendrimers, benzyl ether dendrimers, phenylacetylene dendrimers, carbosilane dendrimers, convergent dendrimers, polyamine, multi-armed PEG polyamide dendrimers as well as dendrimers described in U.S. Patent Application No. 61/467,573; and U.S. Pat. Nos. 4,507,466, 4,558,120, 4,568,737 and 4,587,329, each of which of which are incorporated herein by reference in their entireties. Further exemplary dendrimers include those described in Dendritic Molecules, Concepts, Syntheses, Perspectives. Newkome, et al., VCH Publishers, Inc. New York, N.Y. (1996); also hereby incorporated by reference in its entirety.

A novel solid phase method for the sequential coupling of heterobifunctional macromonomers to form a new class of polymeric materials referred to herein as polymacromers is described. Starting from an azide functional substrate, α-azido, ω-protected-alkyne macromonomers are added step-by-step by thermally initiated click reactions. After each addition step, the terminal alkyne group is deprotected to allow addition of another macromonomer. The use of highly chemoselective click chemistry for the coupling reactions allows virtually any macromonomer to be employed, regardless of its chemical nature. The polymacromers may be left as polymer brushes or dendrimeric structures on the substrate (see, for example, International Patent Application publication WO 10/053,993 and U.S. Provisional Application No. 61/467,573; each of which hereby incorporated by reference in its entirety), or can be isolated as molecular products by photocleavage of, for example, an ortho-nitrobenzyloxycarbonyl (NBOC) linkage incorporated at the substrate interface. The method is illustrated by forming homopolymacromers by sequential coupling of poly(tert-butyl acrylate) macromonomers. The results of characterization of the polymacromer brushes by ellipsometry, contact angle analysis and x-ray photoelectron spectroscopy, and direct measurements of the molecular weights of isolated products by gel permeation chromatography demonstrate that polymacromers can be prepared with a coupling efficiency approaching 100%.

Herein, SPS principles are applied to develop a modular method for the synthesis of a new class of polymers termed “polymacromers”. Polymacromers (PM) are multiblock polymers of a defined sequence produced by coupling heterobifunctional macromonomer building blocks. As prepared, they take the form of a polymer brush because they are bound to a solid substrate but can in principle be isolated by incorporating a cleavable linker at the substrate interface. In conventional polymer synthesis, multiple monomers are joined to form a “polymer”, where the term “polymer” is derived by taking the word “monomer” that describes the repeating unit, adding to it the syllable poly, meaning many, and dropping the syllable mono. Applying the same logic to this new class of materials, that is, by adding poly and dropping mono from the word “macromonomer”, the result is the term polymacromer, which is a suitable and accurate descriptor for the new materials.

Herein, a new SPS method through which a specific, non-symmetric sequence of macromonomers can be joined to produce a new class of polymers, polymacromers (PM) is described. Homopolymacromers with integral molecular weights can be prepared by multiple addition cycles using a single macromonomer while segmented block copolymacromers of any desired sequence can be prepared using different macromonomers in each cycle. Azide-alkyne click chemistry (Angew. Chem., Int. Ed. 2001, 40, 2004-2021; Macromolecules 2010, 43, 1-13; each herein incorporated by reference in its entirety), via the Hüisgen 1,3-dipolar cycloaddition mechanism, is employed as the coupling chemistry because the alkyne group can be readily protected and subsequently deprotected using relatively mild conditions. The click reaction can be initiated at room temperature with a copper catalyst (CuAAC) (Macromolecules 2010, 43, 8693-8702; herein incorporated by reference in its entirety) or thermally (J. Mater. Chem. 2007, 17, 2125-2132; herein incorporated by reference in its entirety) at temperatures as low as 70° C. without catalyst. The high chemoselectivity of the reaction enables the coupling of virtually any macromonomer, regardless of its chemical nature (Science 2005, 309, 1200-5; J. Am. Chem. Soc. 1991, 113, 7152; Biomacromolecules 2005, 6, 2427; each of which hereby incorporated by reference in its entirety). The heterobifunctional macromonomers, comprising one azide end group and a second protected alkyne end group, are prepared by, for example, atom transfer radical polymerization (ATRP) (Macromolecules 1995, 28, 7901; hereby incorporated by reference in its entirety). A limitation of the SPS methods is that the harsh reagents required for release of the final polymer product from the surface can potentially degrade the polymer. To circumvent this problem, a photochemical cleavage method is developed for release of the PM product from the substrate under extremely mild and universal conditions. The NBOC group has been used in the synthesis of photodegradable polymers via embedding of the NBOC moiety in the polymer structure, thus generating a star-type polymer with photocleavable arms (Macromolecules 2007, 40, 3589-3598; herein incorporated by reference in its entirety). However, the polymers were not synthesized in a solid phase synthesis method and photocleavable linker was not incorporated to enable removal of the intact polymer from a surface. Herein, a method that incorporates a photocleavable linker near the surface of a substrate enables solid phase synthesis to be followed by efficient removal of the resultant polymer from the substrate surface without destruction of the polymer brush. Thus, the methods described herein can be characterized as both “grafting to” and “grafting from” in relation to polymer brush generation, and allow one to generate a polymer structure in different ways.

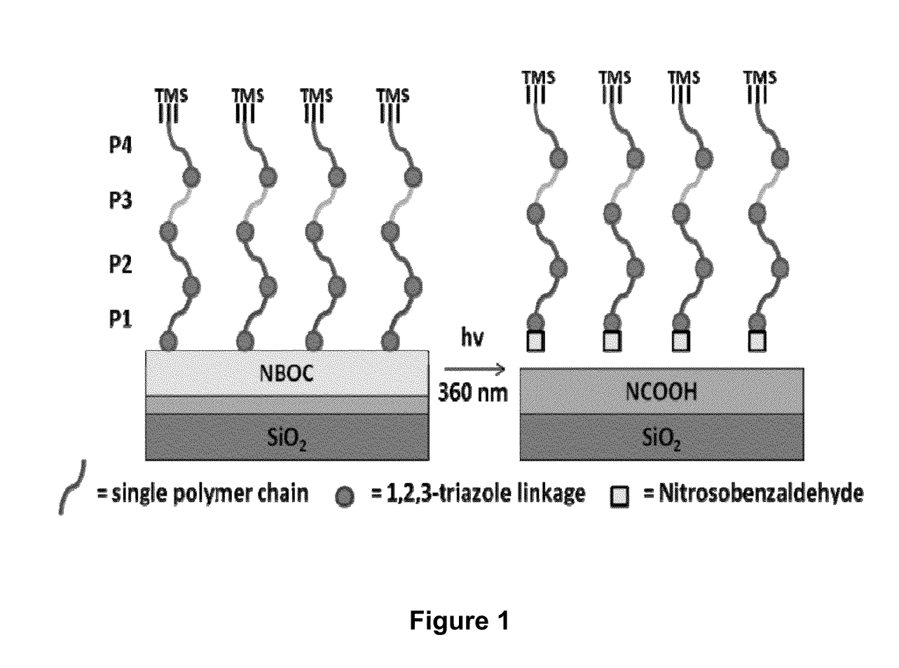

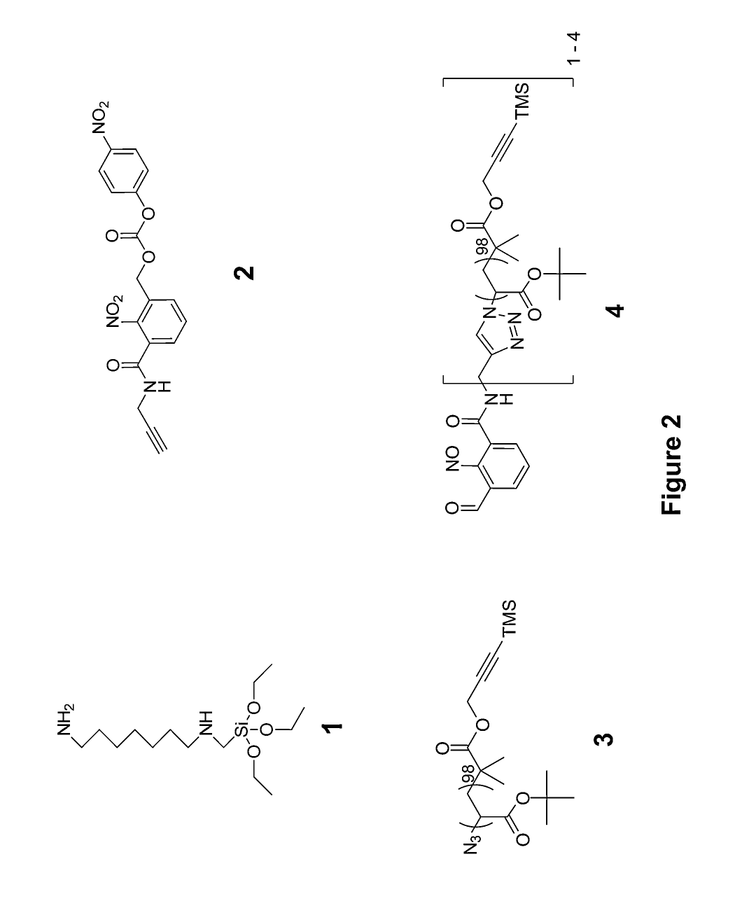

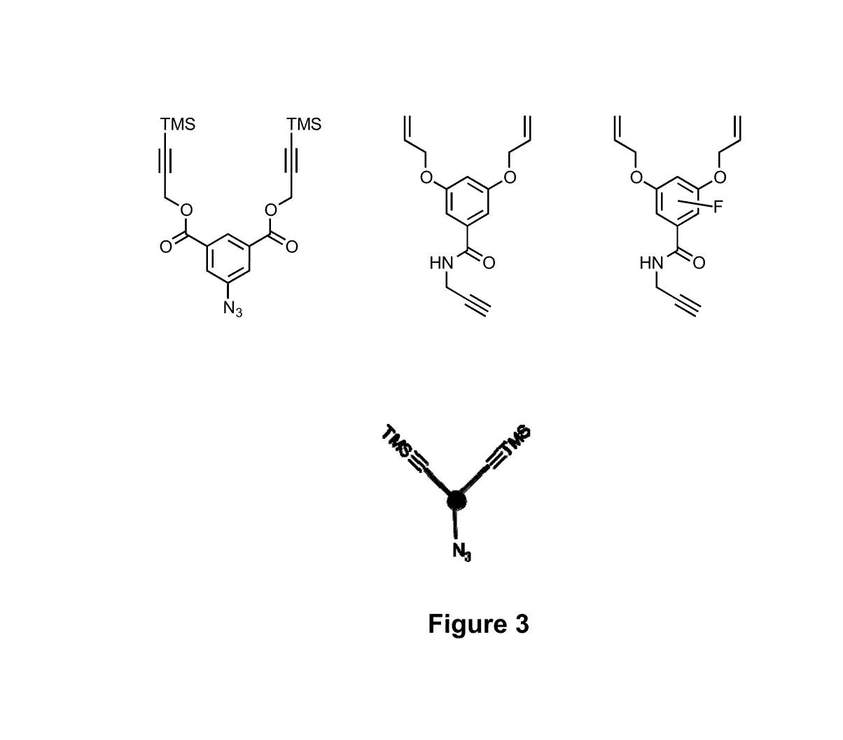

An exemplary process for solid phase synthesis of a PM on a silicon wafer (i.e., SiO₂ surface) is illustrated in FIG. 1 for four addition cycles of an α-azido, ω-trimethylsilane-protected-alkyne poly(tert-butyl acrylate) [PtBA] macromonomer. The process comprises: (1) attachment of an amine terminated primer (1, FIG. 2) to the SiO₂ surface; (2) reaction of the amine terminus with a nitrobenzyloxycarbonyl (NBOC) photo-cleavable linker possessing an alkyne terminus (2, FIG. 2); (3) click reaction of the alkyne terminus with an α-azide, ω-TMS-protected-alkyne macromonomer (M₁, 3, FIG. 2); (4) removal of the alkyne protecting group and repetition of step 3 to add a second polymer (M₂, FIG. 2); (5) repetition of the cycle to add two more polymer units (M₃ and M₄, FIG. 2); and (6) photocleavage and characterization of the final product PM₁₋₄ (4, M₁-M₂-M₃-M₄, FIG. 2).

Covalent attachment of the first macromonomer involves a “click” reaction (i.e., 1,3-cyclopolar addition) between the azide terminus on the first macromonomer and an alkyne group on the functionalized substrate surface, coupling the macromonomer to the surface via a triazole linkage. The result is a substrate coated with a covalently bound brush of polymer that presents trimethylsilane-protected alkyne groups (TMS—≡) at the surface. An alkyne functional surface (≡) is subsequently regenerated by deprotection of the TMS-protected alkyne groups. After surface alkyne groups are regenerated, a second macromonomer, not necessarily the same as the first macromonomer, is attached by another click reaction. The coupling/deprotection process may be applied multiple times to prepare a desired copolymacromer sequence. Because click coupling reactions are highly chemoselective, the chemical nature of the macromonomer blocks is only limited by the ability to synthesize appropriate heterobifunctional building blocks. While the coupling of macromonomers is illustrated herein, the SPS method is quite flexible, and a versatile toolkit of molecular building blocks can be imagined including monomers, branching units, or molecules that furnish specific functions such as sites for cleavage or for subsequent attachment of receptors or ligands. Two simple steps are preferred to add each building block: click coupling of the building block and subsequent deprotection to regenerate surface alkyne groups.

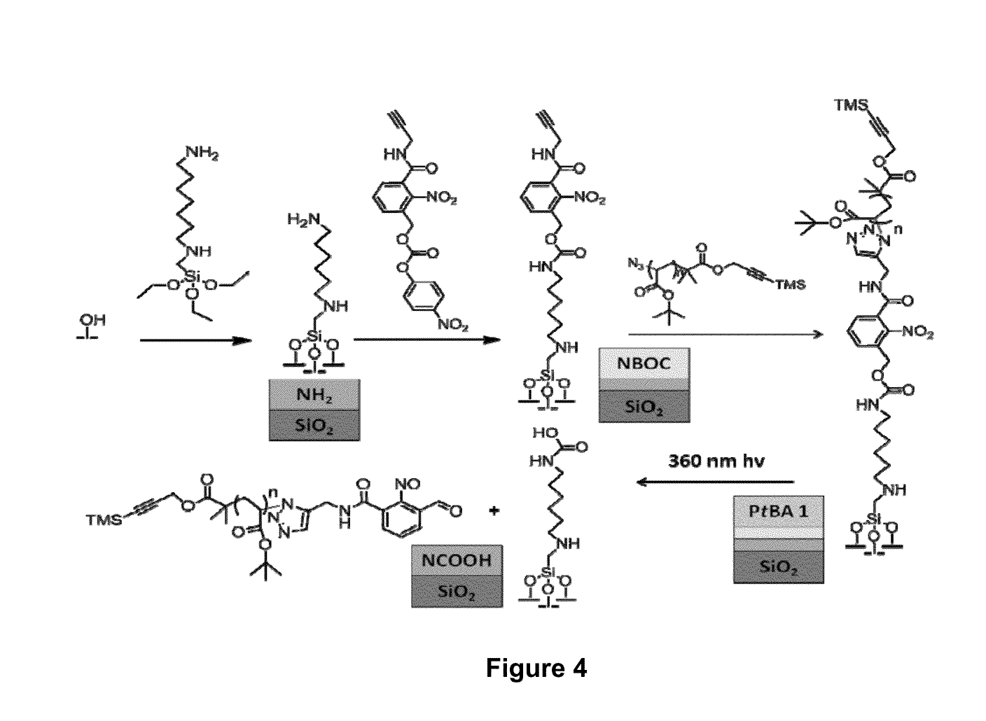

The chemistry involved in FIG. 1 is shown explicitly in FIG. 4. It is evident that SPS of PMs produces first a polymer brush tethered by its end to the substrate. If desirable, the PM can subsequently be released from the substrate and isolated as a molecular polymer product by applying the photocleavage step.

These studies show the development of a robust solid phase method for the step-by-step synthesis of a new class of materials, polymacromers. These interesting new materials are prepared by sequential coupling of α-azido, ω-TMS-protected-alkyne PtBA macromonomers using thermally initiated azide-alkyne click chemistry. The method is illustrated for the preparation of homopolymacromers using the same macromonomer in each addition cycle. The preparation of block copolymacromers may also be prepared by this method. The materials prepared on the substrates are unique polymer brushes, while molecular products may be isolated as linear polymacromers by application of a photocleavage technique. The brushes are unique in that they can be characterized as both “grafting to” and “grafting from”, in the latter case, if a macromonomer is considered equivalent to a monomer. The brush behavior that can be achieved with the new materials spans the entire range of properties possible between traditional “grafting to” and “grafting from” brushes.

Polymer architectures also include linear sequences such as homopolymers, block polymers, alternating polymers and random polymers (WO 10/053,993; hereby incorporated by reference in its entirety). The sequence of monomers incorporated therein determines the classification and properties of polymers. Linear polymers may have homo-functional or heterobifunctional end groups. Brush polymers are another type of polymeric architecture, wherein polymer chains are grafted onto or from a different polymer chain, thus enabling various possibilities for sidechains, grafting density and the like. Branched polymers offer an increasingly diverse and complex polymeric architecture, wherein the polymer chains are branched to provide structures such as star, hyperbranched, dendrimer and complex dendrimeric structures. Polymers can be “grown from” (divergent synthesis) or “attached to” (convergent synthesis) an organic core (for example, a small molecule) or a solid surface (for example, a nanoparticle). When synthesizing polymeric structures, it is desirable to generate as many geometries and architectures as possible using a similar set, or the same set, of small building blocks. It is also desirable to control the polymer architecture, molecular weight (dispersity), functionality and radial density and to incorporate functionality into the polymer using a unique construction approach.

Dendrimers are highly branched organic molecules, and are typically grown from monomeric building blocks in a step-wise or iterative process. In a typical divergent synthetic approach, a core molecule (for example one that contains 2-3 reactive groups) is reacted with new, branched monomers, each containing two or three new, latent functional handles. These new functional handles are in turn unveiled and reacted with yet more monomers, causing the dendrimer to grow exponentially with each generation. Each generation thus represents a new layer or shell on the dendrimeric structure. The result of multiple generations is a three-dimensional spherical polymer. While there are numerous examples of using branched monomers for dendrimer synthesis, branched macromolecules have also been recently been employed (U.S. Provisional Application No. 61/467,573; hereby incorporated by reference in its entirety). This construction of complex polymer architectures takes advantage of complimentary building blocks that enable assembly in various configurations. In some embodiments, the invention provides for higher molecular weight macromolecules for the synthesis of high-molecular weight dendrimers. In some embodiments, the invention provides for dendrimer synthesis with macromolecules comprising protected functional groups to prevent uncontrolled growth of branched structures. The “click chemistry” techniques enable one to elaborate the dendrimer without disturbing other functional groups present and also ensures high yielding steps at each iteration of growth. The selection of branch points allows for control over the polymer density at some radial distance from the dendrimer core. Using click chemistry methods, heterobifunctional macromolecules and small molecules are assembled in a controlled manner to yield high molecular weight novel polymer structures. Protection of one reactive moiety on the building blocks allows selectivity for structural growth. In some embodiments, the methods described herein can be applied to functionalization of nanoparticles. In some embodiments, macromolecules and/or branches comprised of fluorine facilitate observation via fluorine NMR techniques. Dendrimeric structures are also versatile, and have been used in a variety of biomedical and industrial applications (Klajnert, B. et al., Acta Biochemica Polonica 2001, 48, 199; Hawker, et al. Macromolecules 2010, 43, 6625; and PCT/US2009/063282; each of which hereby incorporated by reference in its entirety).

In one aspect, the methods described herein relate to a method for assembling a multilayer polymacromer composition comprising heterobifunctional macromolecular monolayers prepared through solid phase synthesis by sequential deposition of two or more heterobifunctional macromolecular monomolecular layers on a surface. In some embodiments, the multilayer polymacromer compositions can further comprise one or more heterotrifunctional molecules between a substrate surface and a heterobifunctional macromolecular monolayer or between two heterobifunctional macromolecular monolayers.

In one aspect, the invention is comprised of a multilayer polymacromer composition comprising a substrate functionalized with a primer surface group and a linker, wherein the linker comprises a photocleavable functional group, covalently linked to a first heterobifunctional macromolecule or a first heterotrifunctional branch, a surface layer comprising a surface heterobifunctional macromolecule or a heterotrifunctional branch, and n heterobifunctional macromolecule or heterotrifunctional branch layers between the surface layer and substrate, and wherein each n is independently an integer from 0-100.

In one aspect, the invention is comprised of a multilayer polymacromer composition comprising a substrate functionalized with a primer surface group and a linker, wherein the linker comprises a photocleavable functional group, covalently linked to n first heterobifunctional macromolecules or n first heterotrifunctional branches, a surface layer comprising a surface heterobifunctional macromolecule or a heterotrifunctional branch, and a desired number of heterobifunctional macromolecule or heterotrifunctional branch layers between the surface layer and substrate, and wherein each n is independently an integer from 0-100.

In another aspect, the methods described herein relate to a method for generating a multilayer polymacromer composition, the method comprising: (a) functionalizing a substrate with a primer surface group to form a functionalized substrate layer, (b) covalently linking a linker to the primer surface group, wherein the linker comprises a photocleavable functionality and a click moiety terminus, (c) covalently linking the linker with a first heterobifunctional macromolecule or a first heterotrifunctional branch, wherein said heterobifunctional macromolecule or heterotrifunctional branch is comprised of a first click moiety group and a first terminus, wherein said first terminus is comprised of a second click moiety group or a non-click functional group, and (d) covalently linking the heterobifunctional macromolecule or heterotrifunctional branch with a second heterobifunctional macromolecule or heterotrifunctional branch, wherein branching is controlled by selective incorporation of heterotrifunctional branches. In some embodiments, the method further comprises a step comprising the step of repeating step (d) until a multilayer polymacromer composition having (i) a surface layer comprising a surface heterobifunctional macromolecule or heterotrifunctional branch, and (ii) a desired number of heterobifunctional macromolecular layers between the surface layer and the substrate is obtained. In some embodiments, the first terminus is comprised of a second click moiety group. In some embodiments, the second click moiety group is protected, and method further comprises a step between step (c) and step (d) of deprotecting the protected second click moiety group to generate a second click moiety group. In some embodiments, the first terminus is comprised of a non-click functional group. In some embodiments, the methods further comprise conversion of the non-click functional group to a click moiety group. In some embodiments, the density of the macromolecule at a given distance from the substrate is controlled by selective incorporation of branch molecules.

In one aspect, the methods described herein relate to a method for generating a multilayer polymacromer composition, the method comprising: (a) functionalizing a substrate with a primer surface group to form a functionalized substrate layer, (b) covalently linking a linker to the primer surface group, wherein the linker comprises a photocleavable functionality and a click moiety terminus, (c) forming a monomolecular layer by contacting the click moiety terminus of the linker with a first heterobifunctional macromolecule comprising a polymer backbone, a first click moiety terminus and a protected second click moiety terminus, (d) deprotecting the protected second click moiety terminus to form a functionalized monomolecular layer, and (e) forming a second monomolecular layer by contacting the functionalized monomolecular layer with a second heterobifunctional macromolecule comprising a polymer backbone, a first click moiety terminus and a protected second click moiety terminus, or a first heterotrifunctional branch comprising a first click moiety group and at least two protected second click moiety groups. In some embodiments, the method further comprises repeating steps (c) to (e) until a multilayer polymacromer composition having (i) a primer surface layer further comprising a linker, wherein the linker comprises a photocleavable functionality, (ii) a monomolecular layer comprising a heterobifunctional macromolecule, and (iii) a desired number of monomolecular layers between the linker and surface monolayer is obtained. In some embodiments, the methods further comprise the step of removing the multilayer polymacromer composition from the substrate, wherein removal is achieved by irradiation of the photocleavable functionality.

In some embodiments, the photocleavable functionality comprises a nitro-benzyloxycarbonyl group. In some embodiments, the photocleavable functionality comprises a nitrobenzyloxycarbamate. In some embodiments, the photocleavable functionality comprises nitrophenylcarbonyl functionality.

In some embodiments, the polymacromer is not destroyed during removal of the multilayer polymacromer composition from the substrate.

In some embodiments, greater than about 90% of the multilayer polymacromer composition is removed. In another embodiment, greater than about 95% of the multilayer polymacromer composition is removed.

In some embodiments, efficiency of monomolecular layer formation is greater than about 90%. In some embodiments, efficiency of monomolecular layer formation is greater than about 95%.

In some embodiments, the first click moieties are alkyne groups or azide groups.

In some embodiments, the substrate comprises a ceramic, a crystal, a silicon, a metal oxide, a metal alloy, gold, quartz, indium tin oxide, antimony tin oxide, a semiconductor, a semiconductor alloy or any combination thereof. In some embodiments, the substrate comprises SiO₂. In some embodiments, the substrate comprises glass.

In some embodiments, the heterobifunctional macromolecule is comprised of a polymer, a blend of polymers, a polymer precursor, a thermoplastic polymer, or a thermosetting polymer. In some embodiments, the heterobifunctional macromolecule is comprised of a α-silyl alkyne-poly(styrene)-N₃, α-silyl alkyne-poly(tert-butyl acrylate)-N₃, or α-silyl alkyne-poly(methyl methacrylate)-N₃. In some embodiments, the heterobifunctional macromolecule is comprised of a α-trimethylsilyl alkynyl-ω-azido-poly(styrene), α-trimethylsilyl alkynyl-ω-azido-poly(tert-butyl acrylate), α-trimethylsilyl alkynyl-ω-azido-poly(methyl methacrylate).

In some embodiments, the heterobifunctional macromolecule is from about 10 Daltons to about 2,000,000 Daltons.

In some embodiments, the primer surface group comprises an amino group.

In some embodiments, the method for generating a multilayer polymacromer composition comprises: (a) functionalizing a substrate with a primer surface group, wherein the primer comprises a silicon and an amine group, to form a functionalized substrate layer, (b) covalently linking a linker to the primer surface group, wherein the linker comprises a nitrobenzyloxy carbonyl functionality and a click moiety terminus, (c) forming a monomolecular layer by contacting the click moiety terminus of the linker with a first heterobifunctional macromolecule comprising a α-trimethylsilyl alkynyl-ω-azido-poly(tert-butyl acrylate), (d) deprotecting the α-trimethylsilyl alkynyl terminus of the macromolecule to form a functionalized monomolecular layer and, (e) forming a second monomolecular layer by contacting the alkyne terminus of the first monomolecular layer with a second heterobifunctional macromolecule comprising a α-trimethylsilyl alkynyl-ω-azido-poly(tert-butyl acrylate). In some embodiments, the method further comprises the step of repeating steps (c) to (e) until a multilayer polymacromer composition comprising a desired number of monomolecular layers between the linker and a surface monomolecular layer is obtained. In some embodiments, the method further comprises removal of the multilayer polymacromer composition from the substrate, wherein removal is achieved by irradiation of the nitrobenzyloxy carbonyl functionality.

In another aspect, the methods described herein relate to a method for generating a multilayer polymacromer composition, the method comprising: (a) functionalizing a substrate with a primer surface group to form a functionalized substrate layer, (b) covalently linking a linker to the primer surface group, wherein the linker comprises a photocleavable functional group and a click moiety terminus, (c) covalently linking the linker to a first molecule selected from a first heterobifunctional macromolecule M1 and a first heterotrifunctional branch B1, wherein said macromolecule or branch is comprised of a first click moiety group, and (d) covalently linking the first molecule with a second molecule selected from a second heterobifunctional macromolecule M2 and a second heterotrifunctional branch B2, wherein the second molecule is comprised of a second click moiety and a first terminus selected from a non-click functional group and a protected third click moiety, wherein branching is controlled by selective incorporation of heterotrifunctional branches. In some embodiments, the method further comprises the step of repeating step (d) until a multilayer polymacromer composition having (i) a surface layer comprising a surface heterobifunctional macromolecule or a heterotrifunctional branch, and (ii) a desired number of heterotrifunctional branches between the surface layer and the linker is obtained.

In another aspect, the methods described herein relate to a method for generating a multilayer polymacromer composition, the method comprising: (a) functionalizing a substrate with a primer surface group to form a functionalized substrate layer, (b) covalently linking a linker to the primer surface group, wherein the linker comprises a photocleavable functional group and a click moiety terminus, (c) covalently linking the linker to a first molecule selected from a first heterobifunctional macromolecule M1 and a first heterotrifunctional branch B1, wherein said macromolecule or branch is comprised of a first click moiety group, and (d) covalently linking the first molecule with a second molecule selected from a second heterobifunctional macromolecule M2 and a second heterotrifunctional branch B2, wherein the second molecule is comprised of a second click moiety and terminus comprised of a protected third click moiety or a non-click functional group, wherein branching is controlled by selective incorporation of heterotrifunctional branches. In some embodiments, the method further comprises the step of repeating step (d) until a multilayer polymacromer composition having (i) a surface layer comprising a surface heterobifunctional macromolecule or a heterotrifunctional branch, and (ii) a desired number of heterotrifunctional branches between the surface layer and the linker is obtained.

In another aspect, the methods described herein relate to a method for generating a multilayer polymacromer composition, the method comprising: (a) functionalizing a substrate with a primer surface group to form a functionalized substrate layer, (b) covalently linking a linker to the primer surface group, wherein the linker comprises a photocleavable functional group and a click moiety terminus, (c) covalently linking the linker to a first molecule selected from a first heterobifunctional macromolecule M1 and a first heterotrifunctional branch B1, wherein said macromolecule or branch is comprised of a first click moiety group and a second click moiety group, and (d) covalently linking the first molecule with a second molecule selected from a second heterobifunctional macromolecule M2 and a second heterotrifunctional branch B2, wherein the second molecule is comprised of a third click moiety and a protected fourth click moiety, wherein branching is controlled by selective incorporation of heterotrifunctional branches. In some embodiments, the method further comprises the step of repeating step (d) until a multilayer polymacromer composition having (i) a surface layer comprising a surface heterobifunctional macromolecule or a heterotrifunctional branch, and (ii) a desired number of heterotrifunctional branches between the surface layer and the linker is obtained.

In some embodiments, the macromolecules and branches comprise orthogonal functional groups. In some embodiments, the macromolecules comprise functional groups that are orthogonal to the functional groups of the branches. In some embodiments, the macromolecules comprise functional groups that are orthogonal to the functional groups of other macromolecules. In some embodiments, the branches comprise functional groups that are orthogonal to the functional groups of other branches.

In some embodiments, the first click moiety is an azide group and the protected second click moiety is a silyl alkyne group.

In some embodiments, the non-click functional group is converted to a click moiety group. In some embodiments, the non-click functional group is selected from the group consisting of an alcohol, a halogen, a leaving group such as an alkylsulfonate or an arylsulfonate, an ester or a silyl ether.

In some embodiments, the methods further comprise conversion of the non-click moiety functional group to a click moiety functional group.

In another aspect, the invention relates to a multilayer polymacromer composition comprising: (a) a first terminus comprising a nitrophenyl functionality, and (b) n-layers, wherein each layer comprises a poly(tert-butyl acrylate) macromolecule, and wherein n is an integer between 1 and 100. In some embodiments, the macromolecule layers are linked to each other by a triazole. In some embodiments, the composition further comprises one or more branches between one or more macromolecular layers, wherein the branches are bound to the macromolecules by a triazole.

In some embodiments, the nitrophenyl functionality comprises nitrophenylcarbonyl functionality. In some embodiments, the nitrophenyl functionality comprises nitrobenzaldehyde. In some embodiments, the nitrophenyl functionality comprises nitrobenzyl alcohol.

In some embodiments, the heterobifunctional macromolecules described herein are terminated at one end with an azide group (N₃) and on the other end with a trialkylsilyl protected alkyne group. In some embodiments, the trialkylsilyl group is t-butyldimethylsilyl (TBS), triethylsilyl (TES) or trimethylsilyl (TMS). In some embodiments, the trialkylsilyl group is triethylsilyl (TES) or trimethylsilyl (TMS). In some embodiments, the trialkylsilyl group is t-butyldimethylsilyl (TBS). In some embodiments, the trialkylsilyl group is triethylsilyl (TES). In some embodiments, the trialkylsilyl group is trimethylsilyl (TMS).

In some embodiments, a 1,3-dipolar cycloaddition reaction occurs between the azide moiety on a first macromolecule and the alkyne moiety of a second macromolecule to result in covalent attachment between the first macromolecule and the second macromolecule. In some embodiments, the methods described herein can be used for sequential monomolecular layering of heterobifunctional macromolecules wherein the macromolecules each contain two complementary end groups capable of click reactions. In some embodiments, the method can be performed by contacting a first heterobifunctional macromolecule comprising at least one click moiety with a second heterobifunctional macromolecule, having one or more protected click moieties. In some embodiments, the first heterobifunctional macromolecule will be bound to a functionalized surface and present an unreacted click moiety capable of binding to a second heterobifunctional macromolecule having at least an click group. In some embodiments, a heterotrifunctional branch comprising at least one click moiety and at least two protected click moieties may be introduced at any step in the method as desired in order to create branches between the macromolecular layers of the compositions. One of skill in the art will appreciate that the order in which the functional macromolecules described herein are contacted and joined can be reversed.

Each layer can be covalently bound to both the preceding and following layers and/or branches to produce a robust multilayer structure. Because the coupling chemistry used, “click” chemistry, is chemoselective, the layering process can be independent of the chemical nature of the macromolecule so that the constitution of each monomolecular layer can be selected at will. Thus, in some embodiments, the methods and/or compositions comprise selective incorporation of monomolecular layers of differing constitution.

In certain aspects the solid phase methods described herein enable selective removal of the polymacromer compositions from a substrate via irradiation of a photocleavable linker. In some embodiments, the substrate is functionalized with a primer surface group. In some embodiments, the primer surface group is covalently linked to a linker, wherein the linker comprises photocleavable functional group or functionality and a click moiety terminus.

A first step in the methods described herein can involve functionalization of a substrate surface with a surface primer group. The substrate may be of any shape, form or template. For example, in some embodiments, the substrate is a planar substrate or a substantially planar substrate. In some embodiments, the substrate can be a colloidal particle, a nanoparticle, a microsphere, a crystal, or the like. A substrate suitable for use with the methods described herein may comprise any suitable material known in the art, including, but not limited to glass materials, ceramic materials, silicon materials, metal oxide materials, metal alloy materials, gold materials, quartz materials, indium tin oxide materials, antimony tin oxide materials, semiconductor materials, semiconductor alloy materials, organic materials (e.g. organic solid materials) and polymeric materials. The substrate can further comprise carbon nanotubes, polypeptides, peptides, organic polymers, polymer precursors, thermoplastic polymers, a blend of thermoplastic polymers, thermosetting polymers or any combination thereof. The substrate can also comprise a blend of polymers, copolymers, terpolymers, and can be a oligomer, a homopolymer, a copolymer, a block copolymer, an alternating block copolymer, a random polymer, a random copolymer, a random block copolymer, a graft copolymer, a star block copolymer, a dendrimer, or the like.

The substrate is further modified by linking a linker to the primer surface group. The linker comprises a photochemically activated functional group, or photocleavable group, which may be irradiated. The linker further comprises a click moiety terminus, for example an alkyne functional group, that may be covalently linked to a heterobifunctional macromolecule or a heterotrifunctional branch via a click chemistry reaction.

Methods for achieving a functionalized alkyne surface on different substrate surfaces are also known in the art. Exemplary methods include, but are not limited self-assembly of alkyne-functional phosphonate esters for metal oxide substrates (White et al, J. Am. Chem. Soc. 128, 11356-11357 (2006); hereby incorporated by reference in its entirety), alkyne-functional thiols for gold substrates (Troughtoyt et al, J. Am. Chem. Soc. 111, 321-335 (1989); hereby incorporated by reference in its entirety), alkyne-functional silanes for glass substrates (Netzer and Sagiv, J. Am. Chem. Soc. 105, 674-676 (1983); hereby incorporated by reference in its entirety), or alkyne-functional block copolymers (Rengifo et al, Langmuir 24, 7450-7456 (2008); Chen et al, Biomacromolecules 9, 2345-2352 (2008); each of which hereby incorporated by reference in its entirety) for glass and polymeric substrates. Methods for functionalizing glass and silicon wafer can also be accomplished by forming a self-assembled monolayer (SAM) (Ulman, Chem. Rev. 96, 1553-1574 (1996); Dubois and Nuzzo, Ann. Rev. Phys. Chem. 43, 437-463 (1992); Laibinis et al, J. Am. Chem. Soc. 113, 7152-7167 (1991); Senaratne and Andruzzi, Ober, Biomacromolecules 6, 2427-2448 (2005); each of which hereby incorporated by reference in its entirety) of an alkyne functional silane on the substrate surface. One method for functionalizing a glass substrate with surface alkyne groups is to clean the glass substrate by soaking in H₂SO₄ and H₂O₂ (3:1 w/w) for 30 min followed by spin coating of a solution of 50 mg of silane in 1 g of solvent on the galls surface. The surface alkyne groups can then be formed by annealing at 110° C. for 3 hrs under vacuum.

In one aspect, the methods described relate to methods for preparing multilayer functionalized surfaces. In some embodiments, the methods described herein relate to a solid phase method for generating a multilayer polymacromer composition by depositing heterofunctional macromolecules in successive heterofunctional macromolecule monomolecular layers. In some embodiments, a first heterofunctional macromolecule can be deposited onto a linker to a substrate surface by any suitable technique to form a first monomolecular layer. In some embodiments, a first heterotrifunctional molecule can be deposited on a linker to a substrate surface (before the deposition of a first heterobifunctional macromolecule) to form a heterotrifunctional molecule layer.

Suitable methods for depositing heterofunctional macromolecules or heterotrifunctional molecules to form the multilayer polymer compositions described herein include, but are not limited to dip coating, spin coating, spray coating, layer by layer assembly, drop casting, electrostatic painting, or any combination thereof. One skilled in the art will recognize that other methods for dispersing a heterobifunctional macromolecule or a heterotrifunctional molecule over a surface include, for example, dropwise addition or spin coating of a solution comprising a heterobifunctional macromolecule or the heterotrifunctional molecule.

In some embodiments, the macromolecule is comprised of a polymer. In some embodiments, the macromolecule is comprised of a monomer. In some embodiments, the macromolecule is comprised of a monomer unit of about 10-500 Daltons. In some embodiments, the macromolecule is a monomer comprised of a silyl-alkyne and an azide.

In some embodiments, the molecular weight of the macromolecule is about 10 to about 2,000,000 Daltons. In some embodiments, the molecular weight of the macromolecules is about 10 to about 20 Da; about 20 to about 30 Da; about 30 to about 40 Da; about 40 to about 50 Da; about 50 to about 60 Da; about 60 to about 70 Da; about 70 to about 80 Da; about 80 to about 90 Da; about 90 to about 100 Da; or greater, where any stated values can form an upper and/or lower endpoint of a molecular weight range as appropriate or where any of the upper limits may be combined with any of the lower limits. Still other embodiments are discussed herein.

In some embodiments, the coupling efficiency or monomolecular layer formation is from about 50 to about 100%. In some embodiments, the coupling efficiency or monomolecular layer formation is about 50%; about 55%; about 60%; about 65%; about 70%; about 75%; about 80%; about 85%; about 90%; about 95%; about 97%; about 98%; about 99%; or about 100%, where any stated values can form an upper and/or lower endpoint of a range as appropriate or where any of the upper limits may be combined with any of the lower limits. Still other embodiments are discussed herein.

In some embodiments, about 50% to about 100% of the multilayer polymacromer composition is removed from the surface. In some embodiments, about 50% is removed; about 55% is removed; about 60% is removed; about 65% is removed; about 70% is removed; about 75% is removed; about 80% is removed; about 85% is removed; about 90% is removed; about 95% is removed; about 97% is removed; about 98% is removed; about 99% is removed; or about 100% is removed, where any stated values can form an upper and/or lower endpoint of a range as appropriate or where any of the upper limits may be combined with any of the lower limits. Still other embodiments are discussed herein.

In some embodiments, the macromolecule is comprised of a thiol and a terminal alkene. In some embodiments, the macromolecule is comprised of a thiol and a terminal azide. In some embodiments, the macromolecule is comprised of a thiol and an alkyne. In some embodiments, the alkyne is a silyl-protected alkyne.

In some embodiments, the macromolecule is comprised of a non-click moiety functional group and a click moiety functional group. In some embodiments, the macromolecule is comprised of halogen and an azide.

In some embodiments, the methods further comprise conversion of a non-click moiety functional group to a click moiety functional group. In some embodiments, the methods further comprise conversion of a halogen to an azide.

In accordance with the methods described herein, each deposition cycle in the method for generating a multilayer polymacromer composition can involve at least two steps: an interfacial click reaction and deprotection of the protected alkyne end group. In some embodiments, covalent deposition of a first monomolecular layer involves a “click” reaction (e.g., 1,3-dipolar cycloaddition) between azide termini on a first macromolecule and alkyne groups on the linker. The result of the first reaction process is a substrate coated with linker comprising a photocleavable group, wherein the linker is covalently bound to a monolayer of heterobifunctional macromolecules that presents protected alkyne groups at the surface.

In some embodiments, covalent linking involves a “click” reaction between a first click moiety (e.g. a deprotected alkyne group) on a macromolecule, core or branch, and a second click moiety (e.g. an azide terminus) on a macromolecule or branch.

The click reactions described herein can be performed by contacting a first macromolecule comprising a polymer backbone, a deprotected first click moiety terminus and a second click moiety terminus with a second macromolecule comprising a polymer backbone, a first click moiety terminus and a second click moiety terminus. The click reactions described herein can also be performed by contacting a macromolecule comprising a polymer backbone, a deprotected first click moiety terminus and a second click moiety terminus with a heterotrifunctional branch comprising a first click moiety group and at least two second click moiety groups.

In some embodiments, the one click moiety is an alkyne group terminus and another click moiety is an azide terminus, however any type of click chemistry can be used in conjunction with the methods described herein so long as the first and second click moiety termini (e.g. click chemistry pairs) can participate in a selective covalent bond forming reaction with each other.

Examples of click chemical moieties suitable for use with the methods described herein include, but are not limited to, alkynyl groups, azido groups, nitrile groups, conjugated diene groups, epoxide groups, carbonyl groups, aziridine groups, or the like. Exemplary click chemistry pairs can include, but are not limited to, 1,3-Huisgen Dipolar Cycloaddition (e.g. wherein a first click moiety terminus is an alkyne group and a second click moiety terminus is a azide group), 1,3-Huisgen Dipolar Cycloaddition (e.g. wherein a first click moiety terminus is a nitrile group and a second click moiety terminus is an azide group), Diels-Alder Cycloaddition (e.g. wherein a first click moiety terminus is a dienophile group and a second click moiety terminus is a diene group), Non-Aldol Carbonyl Chemistry (e.g. wherein a first click moiety terminus is an isothiocyanate or an isocyanate group and a second click moiety terminus is an amine group), Non-Aldol Carbonyl Chemistry (e.g. wherein a first click moiety terminus is a ketone group and a second click moiety terminus is an alkoxyamine group), Non-Aldol Carbonyl Chemistry (e.g. wherein a first click moiety terminus is an aldehyde group and a second click moiety terminus is an alkoxyamine group), Michael addition (e.g. wherein a first click moiety terminus is an enolate group and a second click moiety terminus is an alpha ketone group), Michael addition (e.g. wherein a first click moiety terminus is an enolate group and a second click moiety terminus is a beta ketone group), Michael addition (e.g. wherein a first click moiety terminus is an enolate group and a second click moiety terminus is an unsaturated ketone group), and Nucleophilic Ring Opening Reactions (e.g. wherein at least one click moiety terminus is an epoxide group). In certain embodiments, two or more polymer layers in the multilayer polymer composition described herein can be covalently joined by the same type of click chemistry reaction (e.g. a 1,3-dipolar cycloaddition click reaction). In some embodiments, two or more polymer layers in the multilayer composition described herein can be covalently joined by the a different type of click chemistry reaction.

Although thermal initiation can be used to perform the click reactions described herein, the click reactions can also be achieved with the addition of a metal catalyst. In some embodiments the metal catalyst is a metal selected from the group consisting of Au, Ag, Hg, Cd, Zr, Ru, Fe, Co, Pt, Pd, Ni, Cu, Rh, W, Ru, Pt, Ni, Cu, and Pd. In some embodiments, one or more metal catalysts can be used to achieve the click reactions described herein. In some embodiments, a copper catalyst is used to achieve the click reaction. In some embodiments, the click reactions described herein are achieved with a Cu(I) metal catalyst. Other suitable methods include, but are not limited to high pressure reaction conditions or irradiation such as by microwaves. In some embodiments, electron-deficient alkynes can also be used to achieve the click reactions described herein (Li et al., Tetrahedron Lett. 2004, 45, 3143-3146; hereby incorporated by reference in its entirety).

The alkyne functional surface (≡) can be regenerated by deprotection of the protected alkyne groups. Deprotection of the terminal alkyne groups can be performed by any method known in the art.

In some embodiments, the macromolecule and/or branch may be comprised of a click moiety at one terminus and a non-click moiety at another terminus Thus, in some embodiments the non-click moiety can be converted to a click moiety at the desired timepoint in preparation for click chemistry reactions at the newly installed click moiety. Thus, in some embodiments, the macromolecule and/or branch is comprised of at least one non-click moiety such as halogen, for example, which is then displaced with azide to form a terminal azide on the macromolecule and/or branch. In some embodiments, the macromolecule and/or branch is comprised of at least one non-click moiety such as an alcohol, for example, which is then converted into a leaving group and displaced with azide to form a terminal azide on the macromolecule and/or branch. The newly installed terminal azide may then further participate in click chemistry reactions.

There is no requirement according to the methods described herein that any subsequent macromolecular layer (or heterotrifunctional branch layer) be the same as that used for the previous macromolecular layer (or heterotrifunctional branch layer) or in any other macromolecular (or heterotrifunctional branch) layer in the dendrimeric composition. Rather, the layering process can be applied to prepare covalently bound multilayers from any desired sequence of macromolecules or branches by repetition of the process described herein. In fact, the chemoselective nature of the click coupling reactions employed herein allows that each subsequent layer can be selected according to one or more desired properties (e.g. molecular weight, hydrophobicity, length . . . etc) of the macromolecule or branch. Another aspect of the methods described herein is that because the macromolecules or branches are joined by a covalent bond, each functionalized layer can be washed and any non-covalently linked species can be eliminated.

The multilayer compositions described herein can comprise any number of macromolecular or monomolecular layers. In some embodiments, the multilayer composition will have one macromolecular layer, two macromolecular layers, three macromolecular layers, four macromolecular layers, five macromolecular layers, six macromolecular layers, seven macromolecular layers, eight macromolecular layers, nine macromolecular layers, or ten or more macromolecular layers. The number of polymer macromolecular layers may in part be dictated by the end use application of the multilayer composition.

The multilayer compositions described herein can comprise any number of heterotrifunctional branch layers. In some embodiments, the multilayer compositions will have one branch layer, two branch layers, three branch layers, four branch layers, five branch layers, six branch layers, seven branch layers, eight branch layers, nine branch layers, or ten or more branch layers. The number of heterotrifunctional branch layers may in part be dictated by the end use application of the multilayer composition.

The α-silylalkyne, ω-azide-macromolecules described herein can be readily prepared by any method known in the art, including, but not limited to atom transfer radical polymerization (ATRP) (Wang and Matyjaszewski. Macromolecules 28, 7901-7910 (1995); hereby incorporated by reference in its entirety). For example, the macromolecules can be readily prepared by use of a trimethylsilane protected alkyne-functional ATRP initiator to polymerize the monomers. Conversion of the resultant terminal bromine groups to azides can be performed by the addition of sodium azide. The macromolecules described herein can also be readily prepared by any method known in the art, including those methods described in the examples.

The macromolecules suitable for use with the methods described herein can comprise any macromolecular backbone terminated at one end with an azide group (N₃) and on the other end with a silane protected alkyne group, and can have any type of backbone (e.g., charged or functional) that can be employed using click chemistry in multilayer assembly. Other macromolecules suitable for use with the methods described herein can comprised any macromolecular backbone terminated at one end with a click moiety functional group and on the other end with a non-click moiety functional group. Exemplary macromolecules are illustrated in FIGS. 2 and 4. Further exemplary macromolecules are provided, for example, in WO 10/053,993 and U.S. Ser. No. 61/467,573; each of which hereby incorporated by reference in its entirety. One skilled in the art will understand that the type of macromolecular backbone selected for use can be selected from a range of macromolecular backbones depending on the intended end use of the multilayer composition generated by the methods described herein. Exemplary polymer backbones suitable for use with the methods described herein include, but are not limited to polymers, copolymers, polyelectrolyte polymers such as poly(acrylic acid) and poly(lysine), polyethers such as polyethylene glycol, polyesters such as poly(acrylates) and poly(methacrylates), polyalcohols such as poly(vinyl alcohol), polyamides such as poly(acrylamides) and poly(methacrylamides), biocompatible polymers, biodegradable polymers, polypeptides, polynucleotides, polycarbohydrates and lipopolymers.

In some embodiments, the same polymer material can be used in each macromolecular layer. In some embodiments, different polymer materials can be used for each macromolecular layer. Further, one skilled in the art will understand that the use of one polymer in a given macromolecular layer of the multilayer composition generated by the methods described herein will not preclude the use of the same polymer in another macromolecular layer of the multilayer composition.

In some embodiments, the polymer backbone can be an α-alkyne-trimethylsilyl-ω-azide-poly(styrene) backbone, an α-alkyne-trimethylsilyl-ω-azide-poly(tert-butyl acrylate) backbone or an α-alkyne-trimethylsilyl-ω-azide-poly(methyl methacrylate) backbone. Accordingly, in some embodiments, the macromolecules used in conjunction with the methods described herein can be an α-alkyne-trimethylsilyl-ω-azide-poly(styrene) terminated at one end with an azide group (N₃) and on the other end with a silane protected alkyne group such as, for example, trimethylsilane (TMS—≡) (TMS-alkyne-PS-N₃), an α-alkyne-trimethylsilyl-ω-azide-poly(tert-butyl acrylate) terminated at one end with an azide group (N₃) and on the other end with a trimethyl silane protected alkyne group (TMS—≡) (TMS-alkyne-PtBA-N₃), or an α-alkyne-trimethylsilyl-ω-azide-poly(methyl methacrylate) terminated at one end with an azide group (N₃) and on the other end with a trimethylsilane protected alkyne group (TMS—≡) (TMS-alkyne-PMMA-N₃). The polymers can be synthesized by ATRP using a trimethylsilane protected alkyne-functional ATRP initiator, followed by conversion of the resultant terminal bromine groups to azides by addition of sodium azide (J. Polym. Sci., Part A: Polym. Chem. 2007, 45, 2913; Macromolecules 2005, 38, 3558; Macromolecules 2012, 45, 3866; each herein incorporated by reference in its entirety). Molecular characteristics of some macromolecules suitable for use with the methods described herein are presented in Table 1.

TABLE 1
Number molecular weights (Mₙ), weight average molecular
weights (M_{w}) and polydispersity indices (PDI) of the
polystyrene, poly(tert-butyl acrylate) and poly(methyl
methacrylate) HetBi polymers determined by gel permeation
chromatography (GPC). Adjusted Mₙ values employ a
universal calibration based upon literature values of Mark-
Houwink-Sakurada parameters to correct the GPC molecular
weight for hydrodynamic volume effects.

| Polymer Code | Mₙ | M_{w} | PDI | Adjusted Mₙ |
|---|---|---|---|---|
| TMS-alkyne-PS-N₃ | 21,500 | 24,000 | 1.12 | 21,500 |
| TMS-alkyne-PtBA-N₃ | 17,000 | 20,000 | 1.17 | 22,170 |
| TMS-alkyne-PMMA-N₃ | 12,000 | 20,000 | 1.67 | 14,600 |

Examples of polymeric backbones suitable for use with the methods described herein, include, but are not limited to organic monomers, organic polymers, polymer precursors, thermoplastic polymers, a blend of thermoplastic polymers, thermosetting polymers or any combination thereof. The substrate can also comprise a blend of monomers, polymers, copolymers, terpolymers, and can be a oligomer, a homopolymer, a copolymer, a block copolymer, an alternating block copolymer, a random polymer, a random copolymer, a random block copolymer, a graft copolymer, a star block copolymer, a dendrimer, or the like.

Exemplary thermoplastic polymers, cationic polymers, anionic polymers, non-ionic polymers, amphoteric polymers and other polymers that can be used as polymer backbones for the polymers described herein, are described in WO 10/053,993 and U.S. Ser. No. 61/467,573; each of which hereby incorporated by reference in its entirety.

Polysaccharides can also be used as polymer backbones for the polymers described herein. Exemplary polysaccharides suitable for use with the methods disclosed herein include, but are not limited to, starch, cellulose, glycogen or carboxylated polysaccharides such as alginic acid, pectin, carboxymethyl amylose, hyaluronan or carboxymethylcellulose.

The use of non-linear polymer backbones can be to increase the areal density of functional groups at an interface of interest. For example, if the areal density of surface functional groups is insufficient to attach a subsequent macromolecular or branch layer, it can be increased by addition of a macromolecular layer of click functional dendrimers.

Other polymers suitable for use as polymer backbones for the polymers described herein include polymers having hydrolyzable or biochemically cleavable groups incorporated into the polymer network structure. Exemplary polymers having hydrolyzable or biochemically cleavable groups incorporated into the polymer network structure include but are not limited to those polymers having hydrolyzable or biochemically cleavable groups incorporated into the polymer network structure described in U.S. Pat. Nos. 5,626,863, 5,844,016, 6,051,248, 6,153,211, 6,201,065, 6,201,072; each of which incorporated herein by reference in its entirety.

The macromolecules may further comprise one or more additional functional groups, such as, for example organic substituents known in the art. In some embodiments, the substituent is selected from alkyl, cycloalkyl, haloalkyl and halogen. In some embodiments, substituent is alkyl. In some embodiments, substituent is halogen. In some embodiments, substituent is haloalkyl. In some embodiments, substituent is cycloalkyl. These and other embodiments will be evident to one of skill in the art.

The macromolecules may also contain monomeric subunits, such as, for example subunits that are repeated in the macromolecule. In some embodiments, the subunits are identified by parentheses on the macromolecular drawings, and are repeated n times. In some embodiments, n=about 1-1000; about 1-500; about 1-200; about 1-100; about 1-50; about 1-30; about 1-20; about 1-10; about 1-5; about 1-2; about 2-10; about 10-20; about 20-30; about 30-40; about 40-50; about 50-75; about 75-100; about 100-200; about 200-300; about 300-400; about 400-500; about 500-1000; about 1,000-2,000; about 2,000-3,000; about 3,000-4,000; about 4,000-5,000; and about 5,000-10,000, where any stated values can form a lower and/or upper endpoint of a numerical range as appropriate or where any of the lower limits can be combined with any of the upper limits.

The molecular weights of the macromolecules described herein can be of any molecular weight suitable for use in generating and using the multilayer polymacromer compositions described herein. In some embodiments, the macromolecule can have a molecular weight of from about 100 Da to about 2,000,000 Da. In some embodiments, the molecular weight of the macromolecule is about 100 Da to about 500 Da; about 500 Da to about 1000 Da; about 1 kDa to about 2 kDa; about 2 kDa to about 3 kDa; about 3 kDa to about 4 kDa; about 4 kDa to about 5 kDa; about 5 kDa to about 10 kDa; about 10 kDa to about 20 kDa; about 20 kDa to about 30 kDa; about 30 kDa to about 40 kDa; about 40 kDa to about 50 kDa; about 50 kDa to about 75 kDa; about 75 kDa to about 100 kDa; about 100 kDa to about 200 kDa; about 200 kDa to about 250 kDa; about 250 kDa to about 300 kDa; about 300 kDa to about 350 kDa; about 350 kDa to about 400 kDa; about 400 kDa to about 450 kDa; about 450 kDa to about 500 kDa; about 500 kDa to about 550 kDa; about 550 kDa to about 600 kDa; about 600 kDa to about 650 kDa; about 650 kDa to about 700 kDa; about 700 kDa to about 750 kDa; about 750 kDa to about 800 kDa; about 800 kDa to about 850 kDa; about 850 kDa to about 900 kDa; about 900 kDa to about 950 kDa; about 950 kDa to about 1 kDa; about 1,000 kDa to about 1,500 kDa; or about 1,500 kDa to about 2,000 kDa, where any stated values can form a lower and/or upper endpoint of a molecular weight range as appropriate or where any of the lower limits can be combined with any of the upper limits.

The molecular thickness of the multilayer compositions described herein can be of any thickness and may in part be dictated by the end use application of the multilayer composition. In some embodiments, the multilayer composition can have a thickness from about 1 nm to about 100 nm, from about 2 nm to about 50 nm, from about 3 nm to about 25 nm, from about 4 nm to about 15 nm, from about 5 nm to about 10 nm. In some embodiments, the multilayer composition can have a thickness from about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, or about 16 nm or greater.

In some embodiments, the multilayer compositions can include a polymer comprising one or more effector moieties. In some embodiments the polymer in one or more layers of the multilayer compositions comprises an effector moiety. In some embodiments, the multilayer compositions can include a surface macromolecular layer comprising a macromolecule comprising one or more effector moieties. As used herein, the term “surface macromolecular layer” refers to the surface macromolecular layer formed after deposition of a macromolecule or branch according to the methods disclosed herein. In some embodiments, the macromolecule in a surface macromolecular layer will have at least one terminus which is not covalently bound to a substrate or to another macromolecule. In some embodiments, the at least one terminus of the macromolecule in a surface macromolecule layer that is not covalently bound to a substrate or to another hetero-bifunctional macromolecule is a silane protected alkyne group terminus.

The effector moiety can be any type of molecule. For example, the effector moiety can be a polypeptide (e.g. an enzyme or an antibody or a fragment thereof), an oligonucleotide, a lipid, a carbohydrate, a small molecule, a ligand, a catalyst, a dye, a label, a sensor, an analyte or any combination thereof. In some embodiments, the effector moiety functions as a cleavable group. In some embodiments, the effector moiety functions as a binding site. In some embodiments, the effector moiety can be a thermochemically reactive group, a photochemically reactive group, or mixtures thereof. Suitable thermochemically reactive group and photochemically reactive groups are described in U.S. Pat. Nos. 5,858,653 and 6,465,178 and in U.S. Published Patent Application 20030113792 (Ser. No. 09/521,545), each of which incorporated by reference in its entirety.

Many methods for attaching effector moieties to polymer backbones are known in the art and any suitable method can be used. Suitable methods include, but are not limited to those described in Lvov et al, J. Phys. Chem. 1993, 97, 13773; Lvov et al, Langmuir 1996, 12, 3038; Cooper, et al, Langmuir 1995, 11, 2713; Locklin et al, Langmuir 2002, 18, 877; Zhang et al, Chem. Commun. 2007, 1395; Sukhorukov et al, Colloids Surf., A 1998, 137, 253; Lvov and Caruso, Anal. Chem. 2001, 73, 4212; Crisp and Kotov, Nano. Lett. 2003, 3, 173; Lvov et al, Macromolecules 1993, 26, 5396; Onda et al, Biotechnol. Bioeng. 1996, 51, 163; Caruso et al, Langmuir 2000, 16, 9595; Schuler and Caruso, Biomacromolecules 2001, 2, 921; and Cortez et al, Adv. Mater. 2006, 18, 1998; each of which incorporated by reference in its entirety.

In some embodiments, the effector moiety is a biologically active molecule. Exemplary biologically active molecules that can serve as an effector moiety in the multilayer compositions described here include, but are not limited to anti-inflammatory agents, anti-pyretic agents, steroidal and non-steroidal drugs for anti-inflammatory use, hormones, growth factors, contraceptive agents, antivirals, antibacterials, antifungals, analgesics, hypnotics, sedatives, tranquilizers, anti-convulsants, muscle relaxants, local anesthetics, antispasmodics, antiulcer drugs, peptidic agonists, sympathomimetic agents, cardiovascular agents, antitumor agents, oligonucleotides and their analogues and so forth.

In some embodiments, the effector moiety is a polynucleotide probe useful for binding or detecting a polypeptide, or another polynucleotide. Accordingly, in some embodiments, the multilayer compositions can be used as a DNA microarray suitable for detecting hybridization of complementary target DNA or DNA fragments in solution. In some embodiments, the effector moiety is an antibody useful for binding a polypeptide. Accordingly, in some embodiments, the multilayer compositions can be used as an immunoarray suitable for detecting binding of an antigen to the effector moiety on the surface of the multilayer compositions described herein.

In some embodiments, the effector moiety is a fluorescent dye or a label (e.g. a fluorophore). Exemplary fluorescent dyes or labels that can serve as an effector moiety in the multilayer compositions described here include but are not limited to, cresyl fast violet, cresyl blue violet, rhodamine-6G, para-aminobenzoic acid, phthalic acids, erythrosine, aminoacridine. fluorescein and its derivatives; rhodamine and its derivatives; cyanine and its derivatives; coumarin and its derivatives; Cascade Blue and its derivatives; Lucifer Yellow and its derivatives; BODIPY and its derivatives; and the like. Exemplary fluorophores include indocarbocyanine (C3), indodicarbocyanine (C5), Cy3, Cy3.5, Cy5, Cy5.5, Cy7, Texas Red, Pacific Blue, Oregon Green 488, Alexa Fluor 488, Alexa Fluor 532, Alexa Fluor 546, Alexa Fluor 568, Alexa Fluor 594, Alexa Fluor 647, Alexa Fluor 660, Alexa Fluor 680, JOE, Lissamine, Rhodamine Green, BODIPY, fluorescein isothiocyanate (FITC), carboxy-fluorescein (FAM), phycoerythrin, rhodamine, dichlororhodamine (dRhodamine), carboxy tetramethylrhodamine (TAMRA), carboxy-X-rhodamine (ROX), LIZ, VIC, NED, PET, SYBR, PicoGreen, RiboGreen, and the like. Descriptions of fluorophores and their use, can be found in, among other places, R. Haugland, Handbook of Fluorescent Probes and Research Products, 9^{th} ed. (2002), Molecular Probes, Eugene, Oreg.; M. Schena, Microarray Analysis (2003), John Wiley & Sons, Hoboken, N.J.; Synthetic Medicinal Chemistry 2003/2004 Catalog, Berry and Associates, Ann Arbor, Mich.; G. Hermanson, Bioconjugate Techniques, Academic Press (1996); and Glen Research 2002 Catalog, Sterling, Va.; each of which hereby incorporated by reference in its entirety. Near-infrared dyes are expressly within the intended meaning of the terms fluorophore and fluorescent reporter group.

Still other embodiments for continued assembly and characterization of various architectural structures, including growth of polymeric macromers from surfaces such as, for example, nanoparticles, are within the scope of this invention. Additional toolkit components useful in the design and construction of the compounds and compositions herein include photodegradable macromolecules or monomers, photodegradable cores for dendron release, thermally degradable monomers, and additional heterobifunctional macromolecules.

The application of the methods and compositions described herein may be useful in the context of, for example, energy conversion storage devices, solar cell fabrication, adhesion, self-cleaning surfaces, drug delivery vehicles, and stem cell scaffolds.

The SPS process for polymer brush synthesis is both extremely simple and versatile. Two steps are involved with each deposition cycle: an interfacial click reaction and deprotection of the silane protected alkyne end group. The materials produced are technically poly-(triazoles) by nature of the triazole linkage formed when macromonomers are coupled. A new nomenclature, that is, polymacromers, is used to describe the novel materials prepared by the SPS method for a number of reasons. First and foremost, the IUPAC nomenclature is cumbersome. Second, materials of this nature have not been prepared before and would be difficult to prepare by other means, meriting a unique name for a unique material. For example, alternating block copolymers of PMMA and PtBA are difficult to prepare directly by ATRP because the reactivity decreases after PtBA addition, making crossover back to PMMA problematic. Polymacromers constitute a unique type of polymer brush that can be characterized as both “grafting to” and “grafting from”. Normally, “grafting from” refers to the addition of a monomer while “grafting to” denotes addition of a preformed polymer. The coupling of multiple macromonomers clearly has attributes of both. In contrast to conventional brushes, the areal density and total molecular weight of polymacromer brushes can be controlled independently by selection of the macromonomer molecular weight and the number of addition cycles. Polymacromer brushes therefore smoothly span the limits between what currently is referred to as “grafting to” and “grafting from”; SPS of macromonomers is capable of preparing any brush that falls between these two extremes. Another interesting aspect of polymer brushes prepared by SPS is that the polydispersity is predicted to decrease with the number of macromonomers added because these are end-linking reactions (J. Am. Chem. Soc. 1936, 58, 1877-1885; herein incorporated by reference in its entirety). Incorporation of cleavable linkers to the substrate so that the reaction conversions and polydispersity may be measured directly by size exclusion chromatography can also occur.

Thermal initiation is used in the Examples herein because of its simplicity; however, synthesis by copper-catalyzed solution phase click reactions is also within the scope of the invention. Coupling (i.e., reaction) from solution, however, is complicated by the effect of the solvent on polymer chain dimensions and density as well as the propensity for the reacting polymer to physisorb at the surface (J. Polymer 1999, 40, 525; J. Phys. II 1995, 5, 1441; J. Phys. (Paris) 1990, 51, 1313; each herein incorporated by reference in its entirety). For example, it has been shown that the rates of interfacial reactions can increase by several orders of magnitude when the polymer in solution physisorbs at the surface (Macromolecules 2004, 37, 516; herein incorporated by reference in its entirety). Click reaction in the melt state is not subject to solvent effects; the thin film or reactive polymer can be deposited by a simple spin-coating process.

Because the interfacial click reaction is orthogonal to other chemistries, virtually any type of polymer backbone (e.g., charged or functional) can be employed. While the method was illustrated herein for PS, PtBA, and PMMA layers, ATRP is capable of producing HetBi polymers from a wide variety of monomers, and any of these could be employed. The number of other building blocks that could be employed in this scheme is only limited by imagination. For example, appropriate HetBi monomers can be synthesized, and heterotrifunctional molecules can be used to impart chain branching. SPS in principle provides a rich toolkit for the synthesis of nonsymmetric sequenced polymers of almost any structure and architecture.

The most important limitation of SPS is that asymmetry in molecular weight can reduce the conversion of the interfacial reaction due to steric hindrance, not unlike the difficulty in preparing higher generation dendrimers. This complication can be circumvented, however, by the use of nonlinear functional materials to increase the areal density of functional groups at an interface of interest. For example, if the areal density of surface functional groups is insufficient to attach a subsequent layer, it can be increased by addition of a layer of click functional dendrimers. A number of other orthogonal chemistries can also be employed in SPS, some of which may not require a protection step.

The following examples illustrate the present invention, and are set forth to aid in the understanding of the invention, and should not be construed to limit in any way the scope of the invention as defined in the claims which follow thereafter.

### EXAMPLES

### Synthesis of NBOC

Materials.

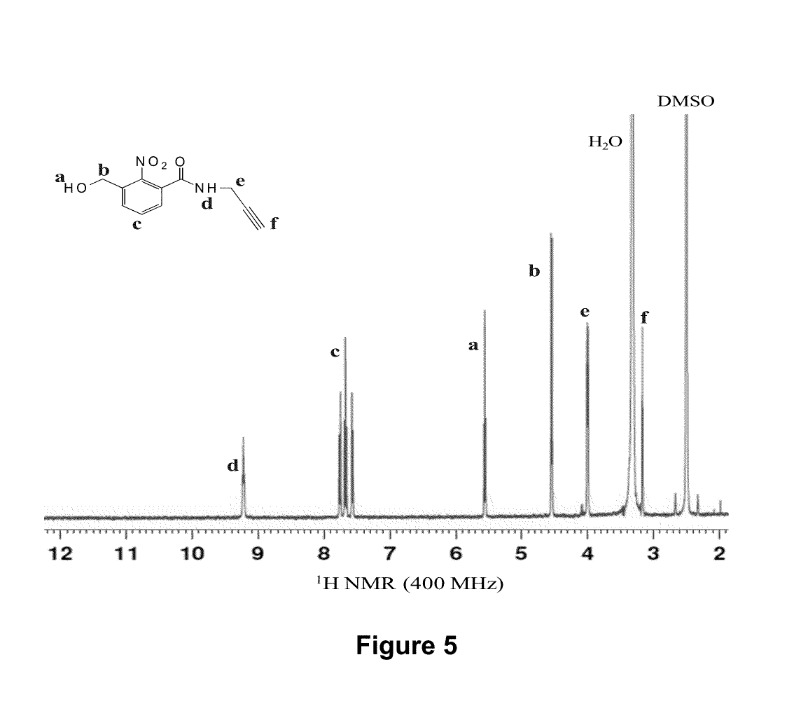

All reagents were purchased from Aldrich Chemical Co. and were used as received. Compound (I) was synthesized according to literature procedures. (Johnson et al. Macromolecules 2007, 40, 3589-3598; hereby incorporated by reference in its entirety). The ¹H NMR (400 MHz) for Compound (1) is shown in FIG. 5.

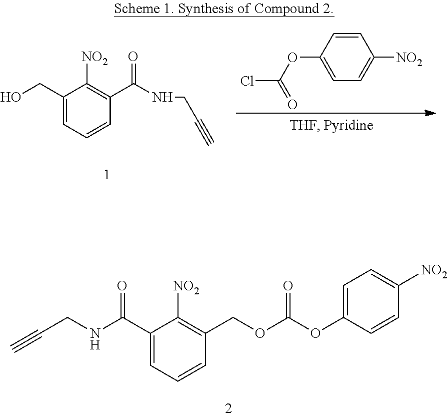 [SMILES: C#CCNC(=O)c1cccc(CO)c1[N+](=O)[O-] ; O=C(Cl)Oc1ccc([N+](=O)[O-])cc1 ; C#CCNC(=O)c1cccc(COC(=O)Oc2ccc([N+](=O)[O-])cc2)c1[N+](=O)[O-]]

Synthesis of Compound 2

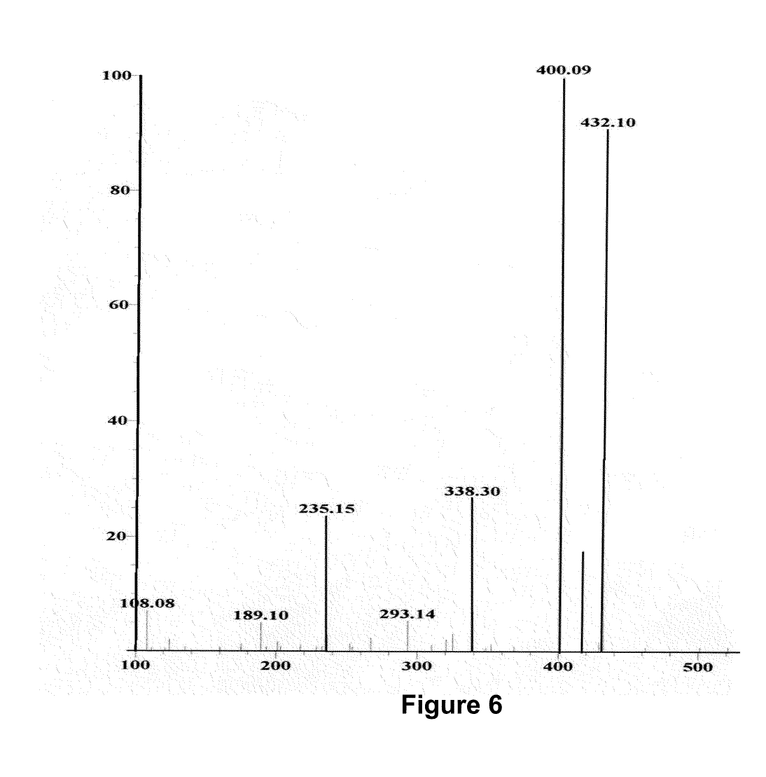

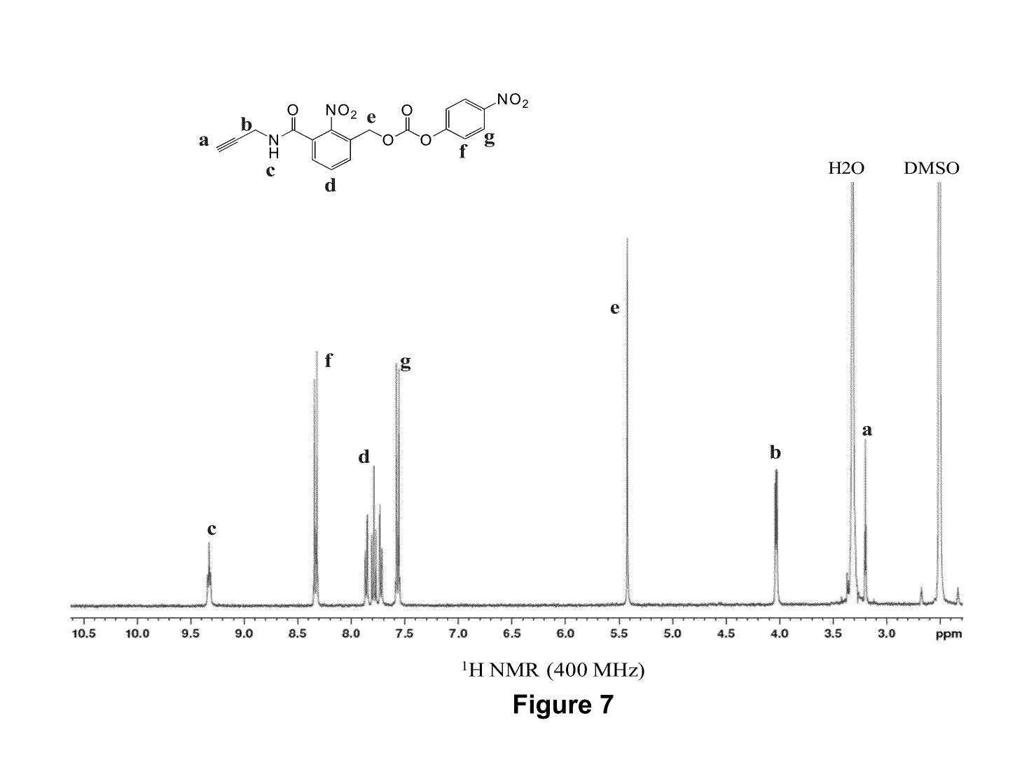

(Scheme 1) (Macromolecules 2007, 40, 3589-3598; hereby incorporated by reference in its entirety): Compound 1 (300 mg, 1.28 mmol) was dissolved in anhydrous THF (9 mL). Then pyridine (0.15 mL) was added to the solution followed by slowly adding 4-nitrophenyl chloroformate THF solution (282 mg, 1.4 mmol, in 3 mL THF) under argon atmosphere. The mixture was stirred for 1 day at room temperature. Then THF was removed under vacuum. EtOAc (150 mL) was added to the residual material and the solution was washed with H₂O (50 mL×2) and saturated aq. NaHCO₃ (100 mL×3). The organic layer was separated and dried with anhydrous Na₂SO₄. After removing the solvent, column chromatography (silica, EtOAc/Hexanes 1:1) gave a light yellow solid as the product (408.8 mg, 80%). MS calculated for C₁₈H₁₃N₃O₈: 399; (ESI-MS, positive) m/z (%) (FIG. 6): 400 (100, M+H), 338 (25), 432 (85, M+CH₃OH). Melting Point: 144° C. FIG. 7: ¹H NMR (400 MHz, DMSO) δ 9.33 (s, 1H), 8.33 (d, J=9.2 Hz, 2H), 7.87 (s, 1H), 7.85 (s, 1H), 7.79 (t, J=7.7 Hz, 1H), 7.73 (d, J=1.5 Hz, 1H), 7.72 (s, 1H), 7.57 (d, J=4.8 Hz, 1H), 7.57 (d, J=9.2 Hz, 2H), 5.42 (s, 2H), 4.03 (dd, J=5.5, 2.5 Hz, 2H), 3.20 (s, 1H). For complex materials thermogravimetric analysis (TGA) is the method of choice for characterization of melting point (Macromolecules 2010, 43, 6549-6552; hereby incorporated by reference in its entirety).

Substrate Preparation:

Four silicon wafers (3″ diameter) were submerged in piranha solution (30:70 H₂O₂:H₂SO₄) for 30 minutes, washed three times with D.I. water, and treated with 15 minutes of UV/O₃. The wafers were then washed again three times in H₂O and dried with N₂ gas. The clean silicon wafers were then cut into 1 cm×1 cm squares to facilitate dip coating and spin coating procedures. Each square wafer was then dipped into a vial containing 0.01% wt/wt of aminohexylaminomethyltriethoxysilane (AHAMTES) in anhydrous toluene for 1 s. This dip coating produced a monolayer thin film of AHAMTES on the silica surface. The primed amine monolayer was then reacted with the NBOC photocleavable linker via amine-carbonate coupling to form a carbamate linkage. 10 mg of the NBOC molecule was dissolved in 20 mL of dimethylformamide (DMF). This NBOC solution was spincoated onto the amine-silicon wafers at 2000 rpm for 1 min. The wafers were then annealed under vacuum overnight at 110° C. to ensure the amine-carbonate coupling went to completion. The surfaces were then washed three times in DMF and dried with N₂ gas.

Solid Phase Synthesis:

The silicon wafers then had alkyne surface functionality and were ready to ‘click’ with azide functional polymers. 20 mg of α,ω-azido,trimethylsilyl(TMS)-protected alkyne, poly(tert-butylacrylate) (PtBA) was dissolved in 10 mL of toluene. Heterobifuctional ‘clickable’ polymers of this nature were readily prepared by atom transfer radical polymerization (ATRP), a living radical polymerization technique (Mₙ=11 kDa) (Macromolecules 2007, 40, 3589-3598; hereby incorporated by reference in its entirety). The polymer solution was spincoated onto the silicon wafers at 1000 rpm for 1 min. The wafers were then annealed under vacuum overnight at 110° C. for a thermal ‘click’ reaction (Langmuir 2008, 24, 7450-7456; hereby incorporated by reference in its entirety). The wafers were removed from the vacuum oven and washed three times with toluene.

The terminal alkyne on the PtBA was then deprotected by removing the TMS group under mild conditions. The surfaces were submerged for 2 hours in a solution of MeOH:Dichloromethane (DCM) [1:10] with excess K₂CO₃ (Biomacromolecules 2008, 9, 2345; hereby incorporated by reference in its entirety). The wafers were then washed three times with MeOH, DCM, and water. The wafers were characterized by water contact angle, ellipsometric, XPS, and AFM measurements at each step.

The sequence of spin coating polymer solution onto the wafers, annealing under vacuum overnight, and then subsequently deprotecting the TMS group was repeated three more times. Finally, the tailor-made polymer thin films were photocleaved from their respective surfaces by irradiation with 360 nm UV light for 2 hr. The surfaces were then washed three times with toluene. The washings from each layer (one, two, three, and four) were collected in separate vials for GPC analysis.

To evaluate the efficiency of the SPS method, four α-azido, ω-TMS-protected PtBA macromonomers were coupled sequentially to silicon wafers as described above. After each cycle, the resultant polymer brushes and the product isolated by photocleavage were both characterized by a battery of methods: X-Ray photoelectron spectroscopy (XPS), water contact angle (WCA), ellipsometry (ELP) and Gel Permeation Chromatography (GPC). The results of all of these independent methods confirm successful step-by-step covalent attachment of PtBA macromonomers to form the final PM product (4, M₁-M₂-M₃-M₄, FIG. 2).

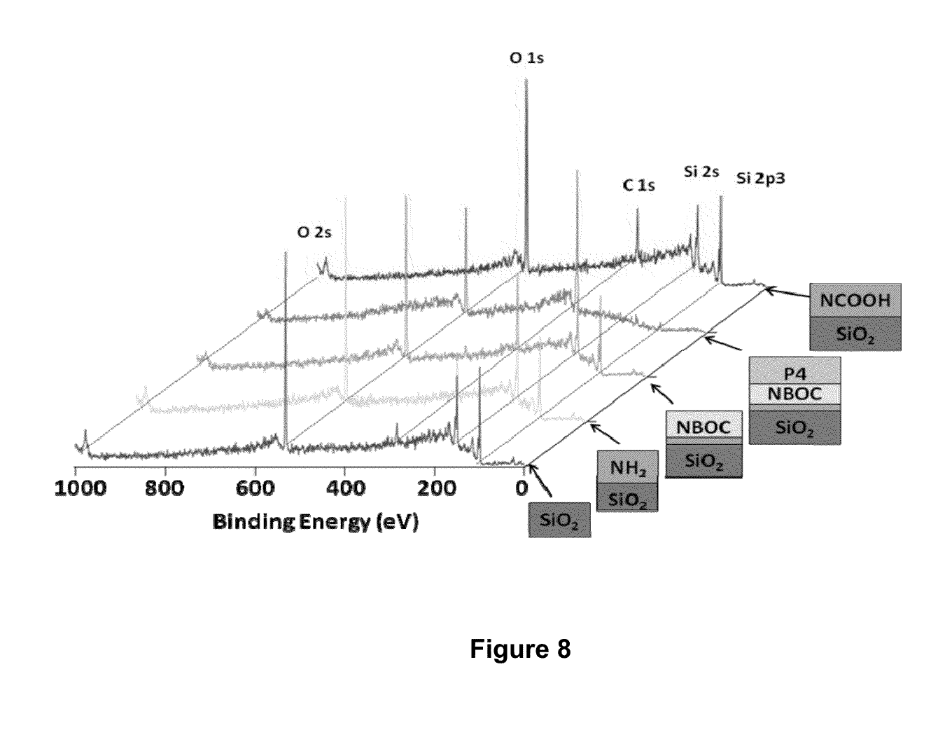

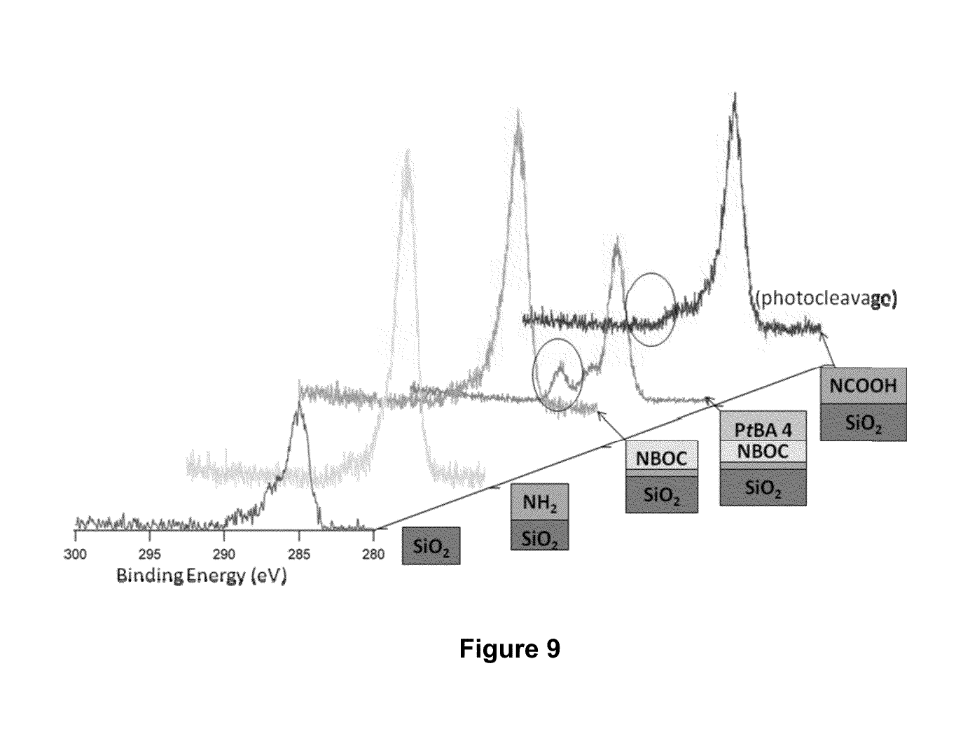

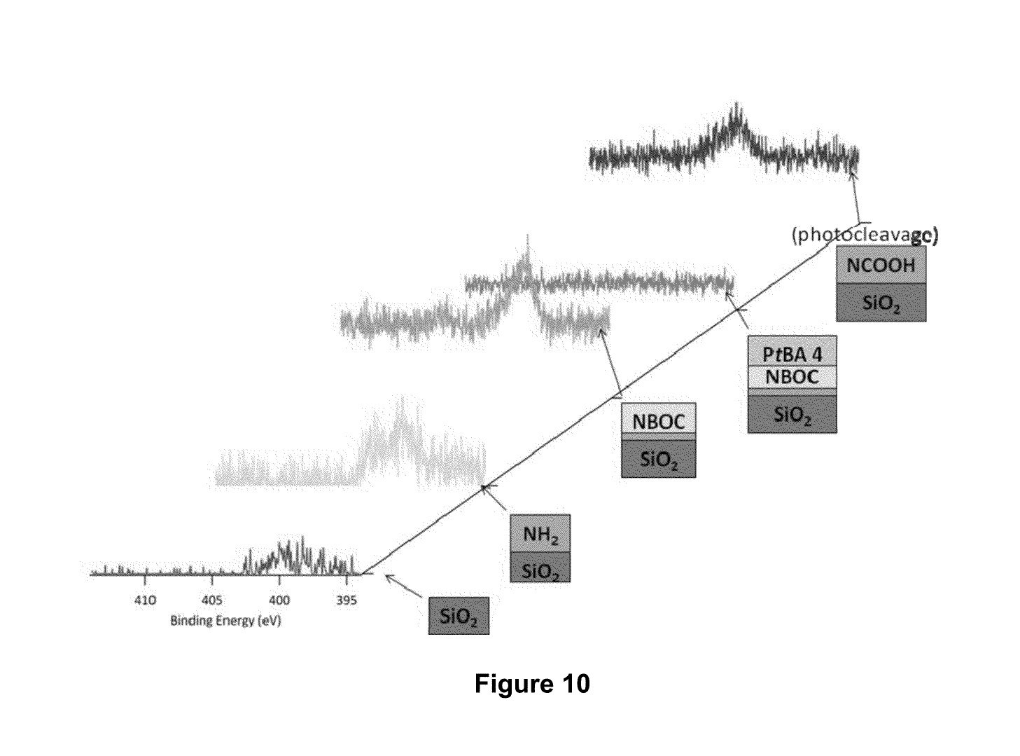

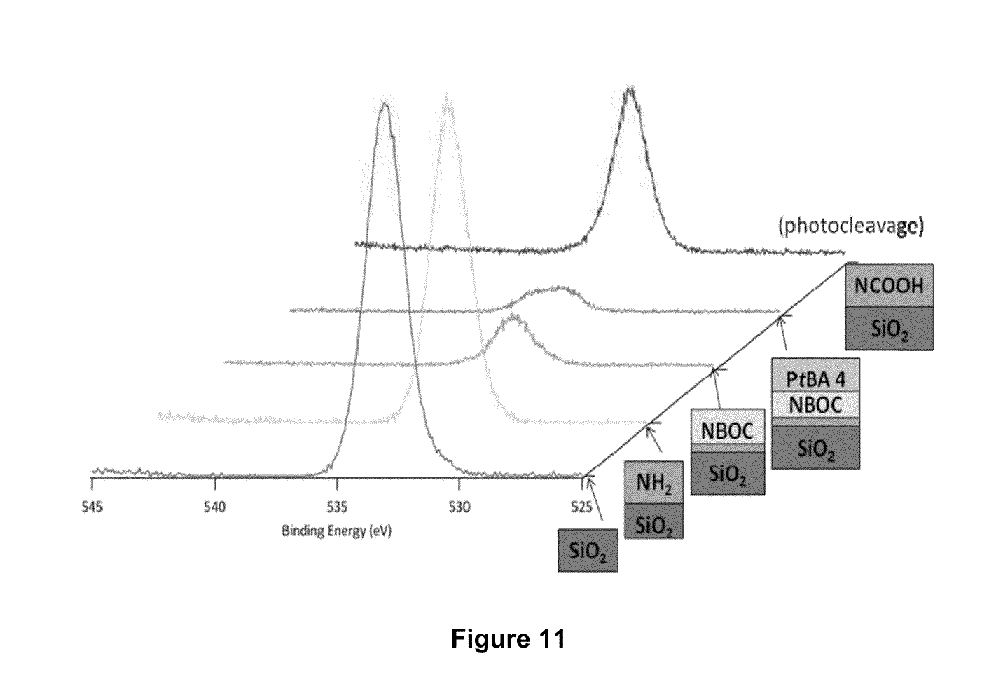

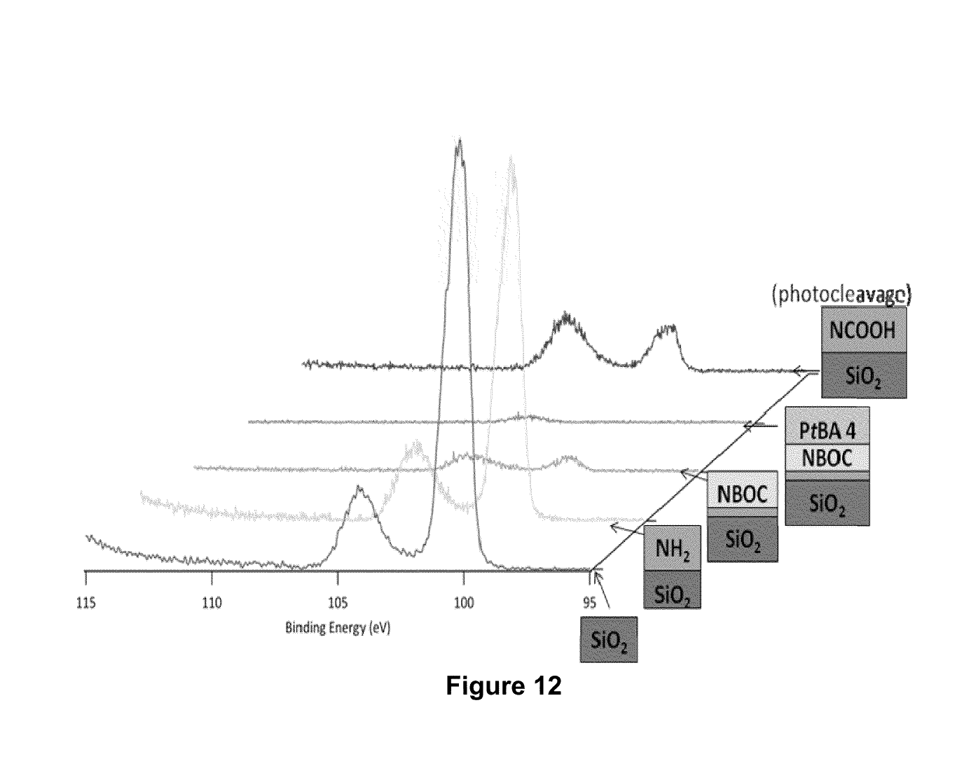

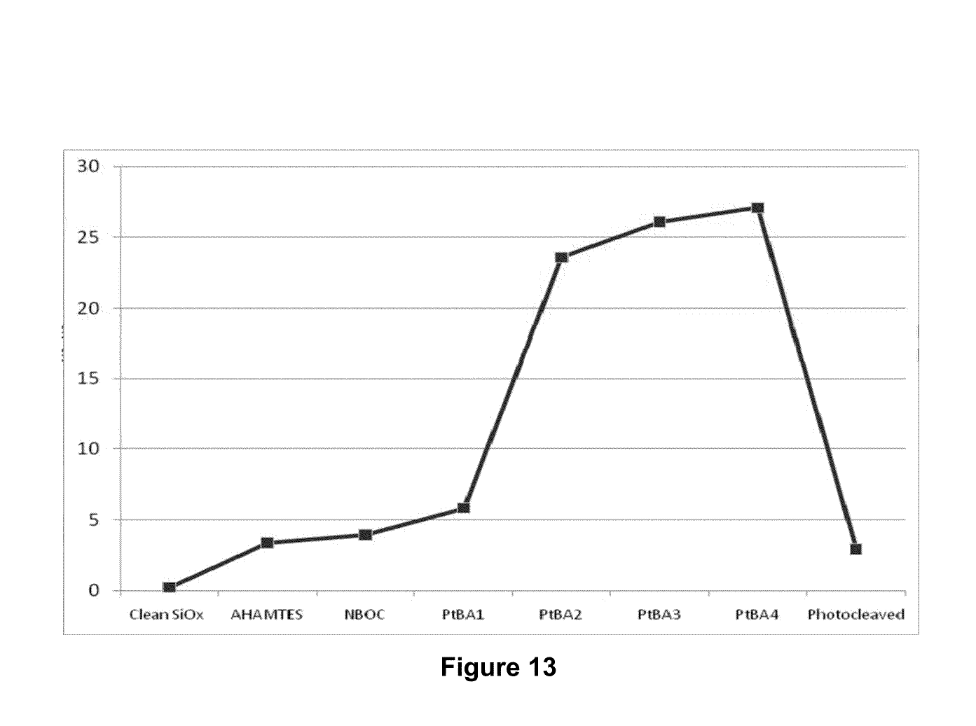

The XPS analysis (PHI 5500 spectrometer, Al Kα monochromator X-ray source at 15 kV and 23.3 mA, 45° take off angle, penetration depth of 6.6 nm) of the surface was performed (FIGS. 8-13) at each addition step in the overall process, M₁, M₁-M₂, M₁-M₂-M₃ and M₁-M₂-M₃-M₄ and after the photocleavage. Controls of the bare SiO₂ surface and the surface primed with AHAMTES were also characterized. The results are summarized in FIGS. 8-13. The qualitative features of the data are: (1) compared to the bare SiO₂ surface, the carbon signal (C 1s, 285 eV signal) increases as the primer and subsequent four layers of PtBA are attached to the surface (FIGS. 8-9); (2) upon photocleavage, the signals are similar to that of the surface with the primer (FIGS. 8-9). These results are consistent with the successful sequential step-by-step additions of four PtBA macromonomers and the complete removal of the final tetramacromer by photochemical cleavage.

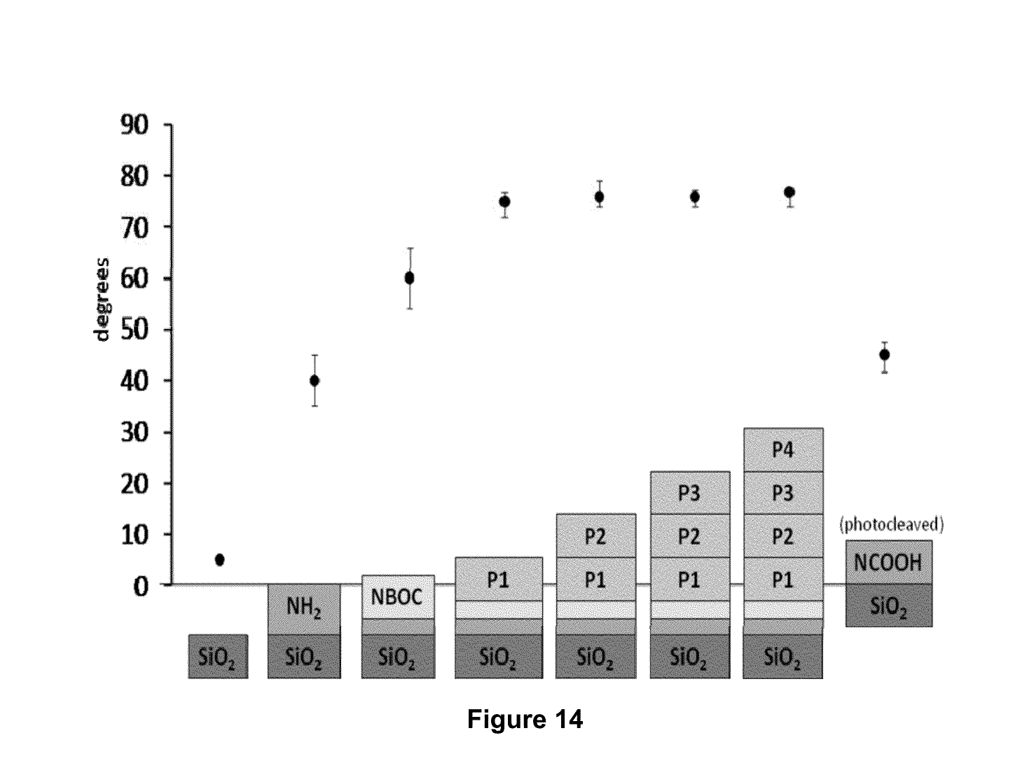

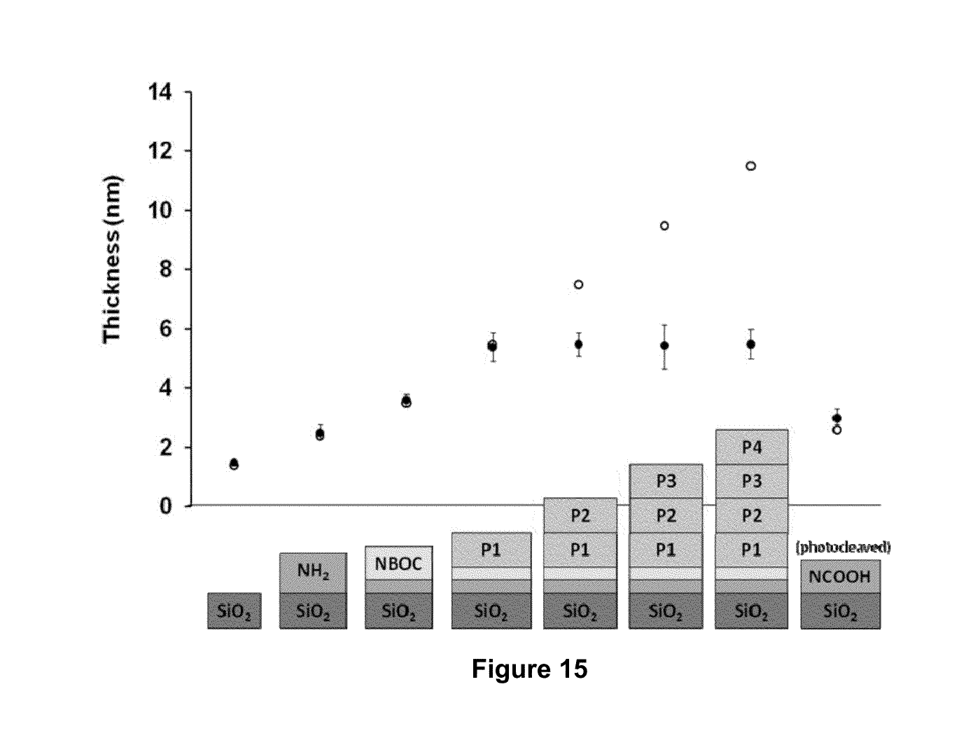

Control experiments: “clicking” PtBA without deprotecting the TMS group first are shown in FIGS. 14 and 15. FIG. 14 shows the water contact angle (WCA) measurements did not change as P2 layered the surface, since the preceding layer was not deprotected and P2 did not covalently bind to P1. P2, P3, and P4 were washed away. FIG. 15 shows the ellipsometry measurements, indicating that P1 was not deprotected and no new layers of polymer covalently bind to the surface. The layers of P2, P3, and P4 were washed away and were not covalently attached.

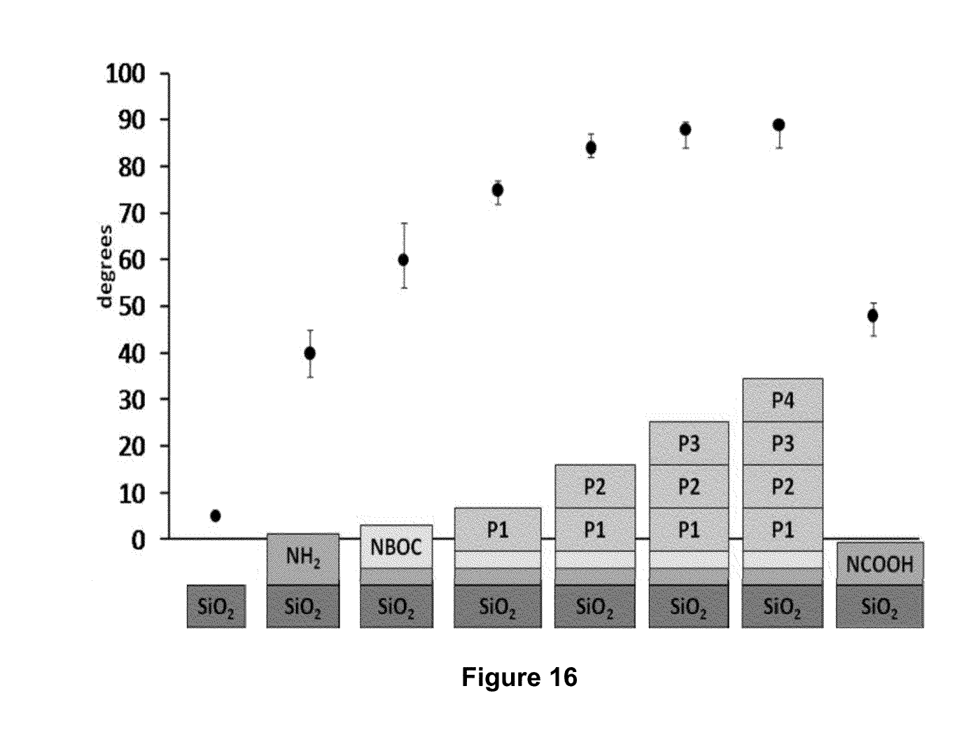

The results of the WCA measurements are shown in FIG. 16. The hydrophilic SiO₂ surface yields a low water contact angle of ˜5′. Upon adding the less hydrophilic layers of primer, NBOC and macromonomers, the CA monotonically increases and approaches a limiting value of 90°, consistent with the value for pure PtBA (J. Am. Chem. Soc. 2000, 122, 1844; hereby incorporated by reference in its entirety). Upon photocleavage of the polymer film, the contact angle returns to a value close to that found for the primer.

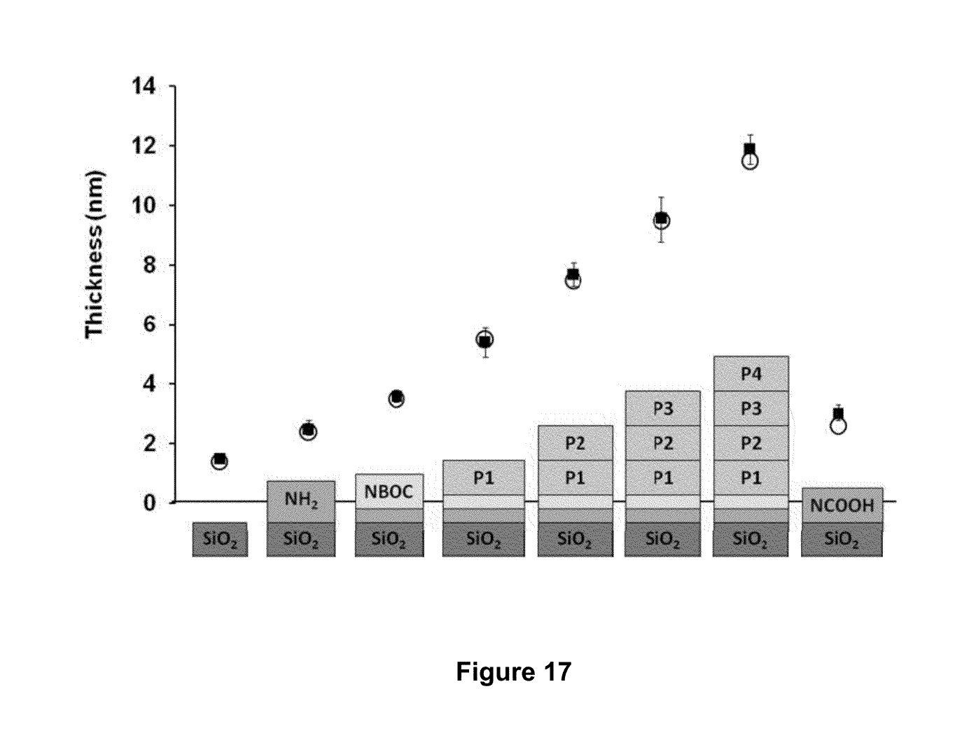

ELP measurements (ALPHA-SE® J.A. Woollam Co., Inc., USA. 70° fixed angle of incidence, Cauchy model) of the film thicknesses provide a quantitative means to evaluate the efficiency of the overall SPS process (FIG. 17). The film thickness increases upon addition of the primer, the NBOC and the four PtBA macromonomers as expected.

The ellipsometric thickness scales linearly with the number of macromonomer addition cycles and compares well with the theoretical thickness calculated assuming 100% conversion for the click reaction for each cycle. The value of the thickness for the photocleaved surface returns to a value close to that for the surface with just the primer. Film thicknesses determined by X-Ray reflectivity measurements also agree well with the ellipsometric thicknesses.

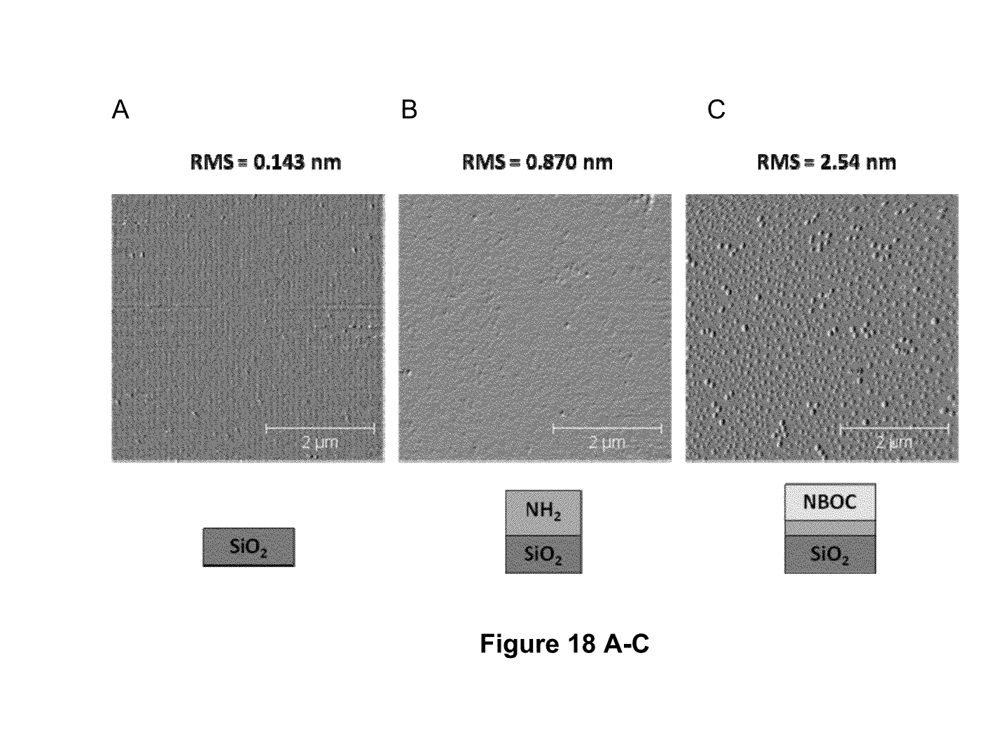

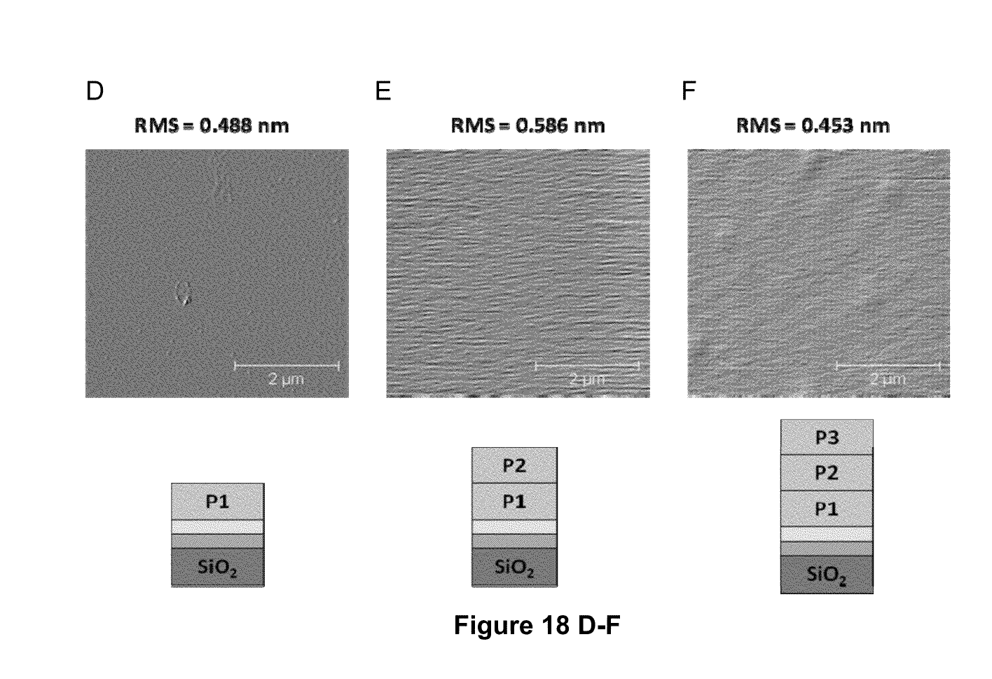

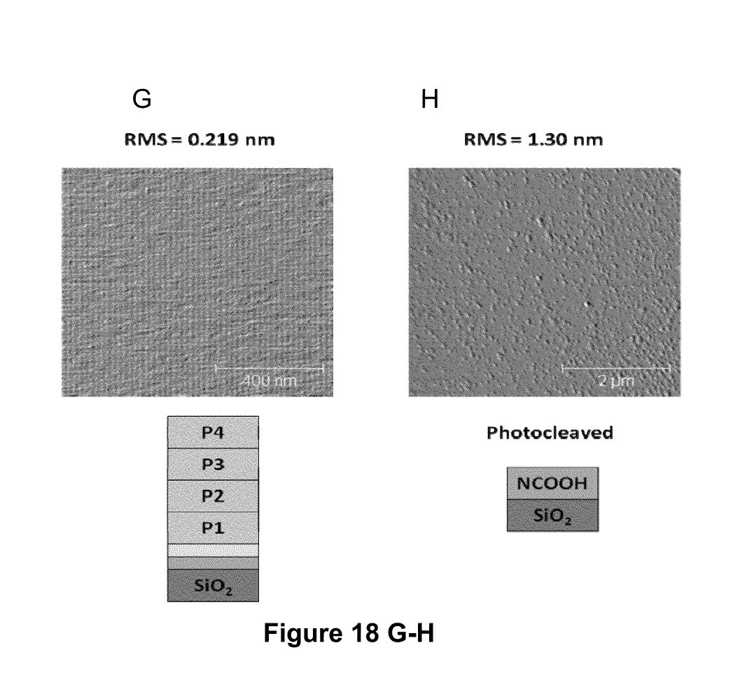

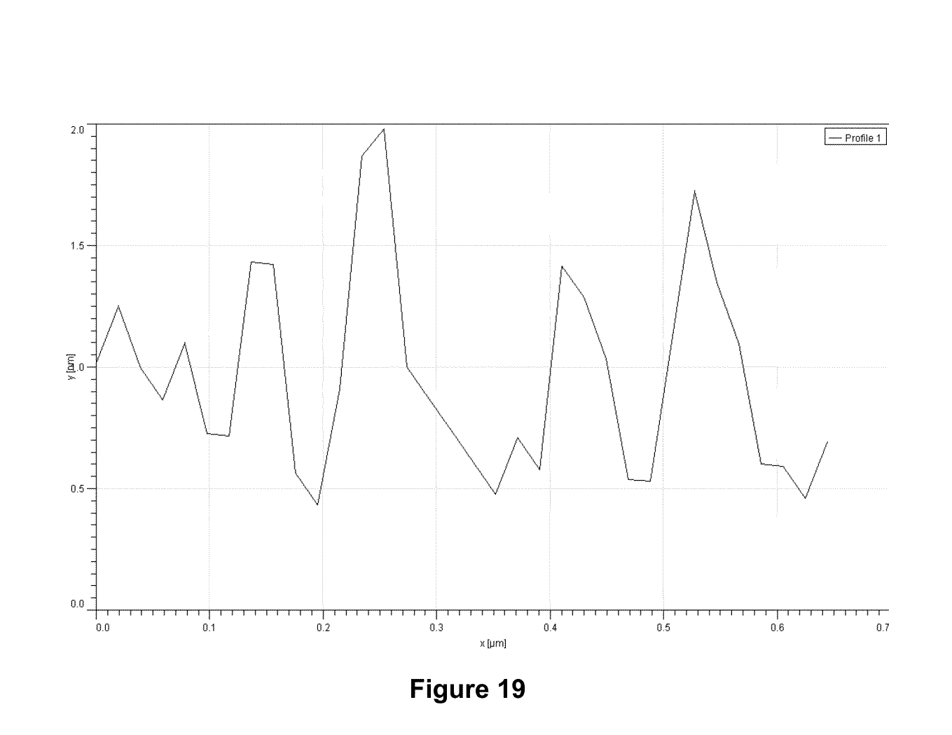

AFM images are shown in FIGS. 18 and 19. The bare silicon oxide surface (FIG. 18A) is not rough with a low RMS value (0.143 nm). After the NH₂ primer is deposited the surface roughness increases slightly (RMS=0.870 nm; FIG. 18B). With the formation of the NBOC primer layer (FIG. 18C), the surface roughness increases substantially (RMS=2.54 nm) and islands of NBOC are visible. These islands form due to phase separation of the NBOC molecule from the solvent while annealing. After the first polymer layer is grown from the surface (FIG. 18D), the roughness decreases (RMS=0.488 nm). The polymer brushes fill the gaps, thereby smoothing the surface. For polymer layers 2 (P2) and 3 (P3) (FIGS. 18E and 18F, respectively), the surface roughness does not change substantially (RMS=0.586 nm and 0.453 nm, respectively); and decreases slightly with polymer layer 4 (P4; FIG. 18G) wherein RMS=0.219 nm). Upon photocleavage of the formed polymacromolecule thin film (FIG. 18H), the surface roughness regenerates to a lever closer to that of the NBOC primer layer (FIG. 18C), providing RMS=1.30 nm and the remnants from the NBOC island formation are visible. A line profile of the NBOC layer (FIG. 18C) is graphically shown in FIG. 19, wherein island height (shown in nm) confirms the monolayer structure.

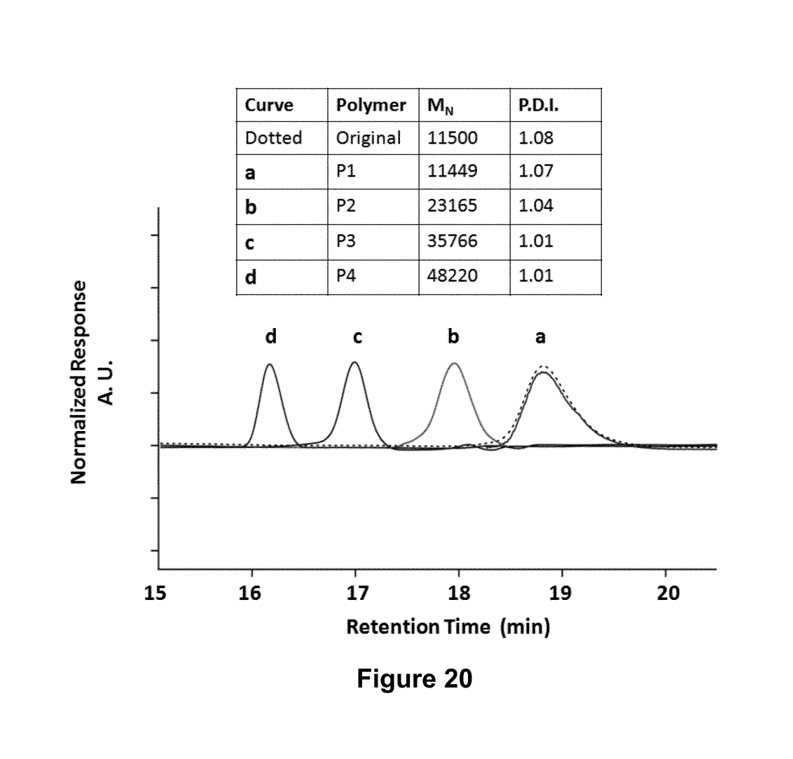

The efficiency of coupling can be probed in more depth by analyzing polymacromers that have been isolated by cleavage from the substrate. GPC analyses (Knauer GPC system with a Knauer K-2301 refractive index detector, three Polymer Laboratories 5 μm particle size PLgel columns, linear polystyrene calibration standards ranging in molecular weight from 580-377,400 Da, THF eluent with a flow rate of 1.0 mL/min at room temperature) of isolated products are shown in (FIG. 20). The relationship between the curves in FIG. 20 and the polymer, M_{N} and P.D.I. are shown in Table 2. The signal quality is low because each silicon substrate yields only a limited amount of product; however it is evident that the molecular weight increases in integral multiples of the number of macromonomers added, consistent with the linear behavior found in the ellipsometry data.

TABLE 2
GPC curves in relation to polymers produced by photocleavage.

| Curve | Polymer | M_{N} | P.D.I. |
|---|---|---|---|
| Dotted | Original | 11500 | 1.08 |
| a | P1 | 11449 | 1.07 |
| b | P2 | 23165 | 1.04 |
| c | P3 | 35766 | 1.01 |
| d | P4 | 48220 | 1.01 |

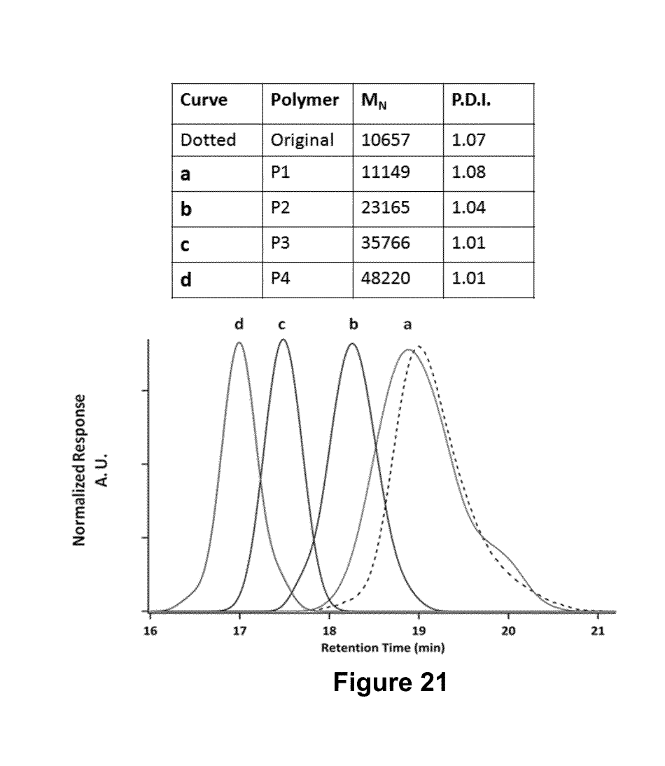

A second GPC analysis is shown in FIG. 21 in which the analysis was performed on a different sample from a different synthesis. These samples were done in the same method as described previously, except that they were scaled up to 4 wafers per GPC trace in order to increase the amount of material collected. The relationship between the curves in FIG. 21 and the polymer, M_{N} and P.D.I. are shown in Table 3. The molecular weights are similar to those reported in FIG. 20.

TABLE 3
GPC curves in relation to polymers produced by photocleavage.

| Curve | Polymer | M_{N} | P.D.I. |
|---|---|---|---|
| Dotted | Original | 10657 | 1.07 |
| a | P1 | 11149 | 1.08 |
| b | P2 | 23165 | 1.04 |
| c | P3 | 35766 | 1.01 |
| d | P4 | 48220 | 1.01 |

The GPC traces do not evidence substantial signals for residual products from preceding cycles, indicating that the conversion of the click reactions for each cycle is nearly 100%, consistent with the findings from the ellipsometric measurements. These results, which are completely independent of the previously described XPS, WCA and ELP measurements, confirm that the step-by-step SPS process proceeds according to the mechanism depicted in FIGS. 1 and 4 to form the anticipated homopolymacromers: M₁, M₁-M₂, M₁-M₂-M₃ and M₁-M₂-M₃-M₄.

### Example 2

### SPS Brush Synthesis

### Synthesis of a Protected Alkyne-Functional Initiator-TMS

Unless otherwise noted, all chemicals were purchased from Aldrich and used as received. In a 100 mL round bottom flask, 3-(trimethylsilyl)propargyl alcohol (5 g, 38.98 mmol), triethylamine (Et₃N 3.93 g, 38.98 mmol) and 50 mL of dry Et₂O were added and stirred in an ice-water bath for 20 min. Bromoisobutyryl bromide (7.8 g, 33.90 mmol) dissolved in 15 mL of dry Et₂O was added drop-wise. After the addition was complete, the reaction was allowed to warm-up to 23° C. and stirring was continued for 24 h. The reaction mixture was poured into ice-water and the organic product was extracted with CH₂Cl₂. The organic phase was washed with 100 mL H₂O (2×) and 100 mL brine (2×), and then dried over anhydrous Na₂SO₄. The solvent was distilled at 30° C. under reduced pressure on a rotary evaporator to yield a slightly yellow liquid that was purified by vacuum distillation to yield 5.3 g of final product (54%), propanoic acid, 2-bromo-2-methyl-, 3-(trimethylsilyl)-2-propynyl ester), a protected alkyne-functional initiator for atom transfer radical polymerization (ATRP). ¹H-NMR δ 4.78 (s, 2H, CH₂), 1.94 (s. 6H, CH₃), 0.08 (s, 9H, Si(CH₃)₃. ¹³C NMR δ 171.77 (CC(O)O), 90.03 (Si—C≡C), 98.55 (C≡C—Si), 55.88 (OCC(O)), 54.56 (C(CH₃)₂), 31.01 (CH₃), −0.83 (CH₃Si).

Synthesis of the Polymers.

TMS-alkyne-PtBA-Br. The monomer, t-butyl acrylate (tBA) (99+% purity), was passed through a basic Al₂O₃ chromatographic column (flash) to remove inhibitor. Monomer (tBA, 2.5 g, 19.53 mmol), solvent (toluene, Acros, 99.8%, 1.5 mL), initiator ((TMS, 13.5 mg, 0.046 mmol), catalyst (CuBr, 8 mg, 0.051 mmol) and N,N,N′,N′,N″-pentamethyldiethylenetriamine (99% purity) ligand (PMDETA, 11.1 mg, 0.062 mmol) were weighed directly in a 25-mL Schlenk tube. After three freeze-pump-thaw cycles, the tube was filled with argon, and the reaction mixture was heated to 70° C. in an oil bath. The side arm of the tube was purged with argon for at least 5 minutes before it was opened for samples to be removed at predetermined times with an airtight syringe. Samples were dissolved in CDCl₃, and the conversion was measured by ¹H-NMR. A part of the solution was injected into a Shimazu LC-10AT gel permeation chromatography system (GPC), equipped with a refractive index detector to measure the number-average and weight-average molecular weights relative to PS standards. Molecular weights were corrected for hydrodynamic volume effects by application of a universal calibration using 0020Mark-Houwink-Sakurada parameters (PS: K=1.41 and a=0.7; PtBA: K=0.33 and a=0.8; PMMA: K=1.04 and a=0.697) and the following formula (eq. 1):

$$log ( M ) = \frac{1}{1 + a} log ( \frac{{K}_{Ref}}{K} ) + \frac{1 + {a}_{Ref}}{a} log ( {M}_{Ref} ) \qquad ( 1 )$$

Once the desired conversion was achieved, the Schlenk tube was removed from the oil bath, allowed to reach room temperature and the polymerization mixture diluted with CH₂Cl₂. This solution was passed through a basic alumina flash column, the catalyst-free mixture was collected and solvent was removed under reduced pressure using a rotary evaporator. Polymer was recovered by filtration after precipitation of a concentrated polymer solution in CH₂Cl₂ with a MeOH/H₂O mixture (7:3 v/v).

β-exchange to (TMS-alkyne-PtBA-N₃)

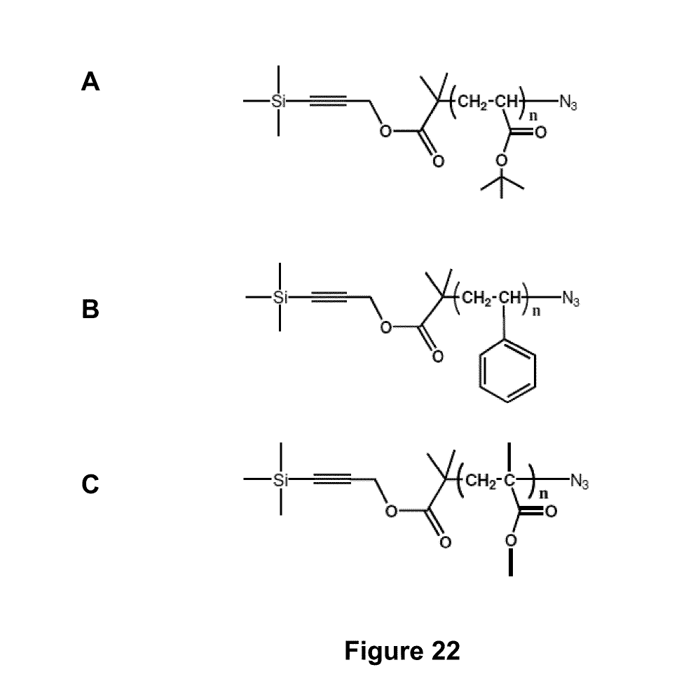

1 g of TMS-PtBA-Br polymer was dissolved in 15 mL of dimethyl sulfoxide (DMSO) and 0.5 g of NaN₃ was added in a 2-neck round bottom flask equipped with a condenser. The slurry was allowed to stir overnight at refluxing temperature. Product was recovered by subjecting the slurry first to a filtration step to remove the excess NaN₃, followed by precipitation in a cooled MeOH/H₂O mixture (7:3 v/v). The collected polymer was redissolved in 5 mL CH₂Cl₂ and this solution filtered to remove any insoluble solids and reprecipitated in the MeOH/H₂O mixture. The collected polymer was dried and used without further purification. Similar procedures were used for the synthesis of TMS-PS-N₃ and TMS-PMMA-N₃. Structures for the 3 polymers are presented in FIG. 22.

Substrate Preparation.

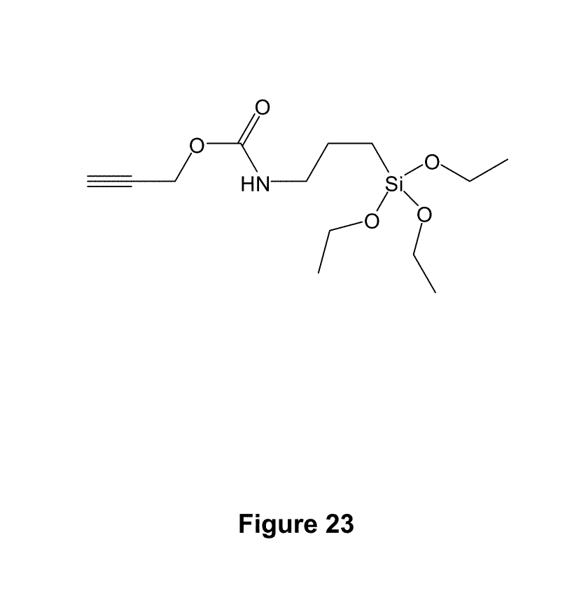

Glass substrates (cover slips or slides) and Si substrates were cleaned by soaking in H₂SO₄ and H₂O₂ (3:1 w/w) for 30 min. Si substrates were also cleaned by exposure to UV and ozone for 15 min and then washing extensively with deionized (DI) water. A solution of 50 mg of silane (FIG. 23) in 1 g of solvent was spin coated on the surface at 2500 RPM for 1 minute and then anneal at 110° C. for 3 hrs under vacuum. The result is a 1.7±0.3 nm thick alkyne silane layer.

Surface Reactivity Study.

The α-TMS-alkyne-β-azide-poly(tert-butylacrylate), α-TMSalkyne-β-azide-poly(polystyrene) and α-TMS-alkyne-β-azide-poly(methylmethacrylate) (shown in FIG. 22) was coupled to the alkyne surface by click chemistry. The first layer of the polymer is spin coated (1000 rpm, 1 min) on top of the functionalized substrate from a solution of 2 mg/ml in toluene. The resulting SiOx/Silane/polymer1 samples were baked at 110° C. for 4-18 hours to facilitate the click reaction. The surface was washed with methanol water and dichloromethane. The alkyne surface is subsequently regenerated by deprotection of the alkyne. In a 20 mL flask, 10 ml CH₂Cl₂, 1 mL methanol and 0.23 g of K₂CO₃ were mixed. The surface was immersed in this suspension thermostated at room temperature to 50° C.±2 and stirred under Ar overnight. The SiOx/Silane/polymer 1 surface is then washed with water, methanol and dichloromethane. This procedure is repeated to make SiOx/Silane/polymer1/polymer2 and then SiOx/Silane/polymer1/polymer2/polymer3.

Characterization.

Sessile drop ethylene glycol contact angle measurements were carried out at room temperature for 8-10 μL droplets with a model 100-00 contact angle goniometer (Rame-Hart, Inc.). Reported values are averages of measurements on more than three different samples at more than three different locations on each sample. X-ray photoelectron spectroscopy spectra were recorded with a PHI 5500 spectrometer equipped with a hemispherical electron energy analyzer, a multichannel detector, and an Al KR monochromator X-ray source run at 15 kV and 23.3 mA. The test chamber pressure was maintained below 2×10⁻⁹ Torr during spectral acquisition. A low-energy electron flood gun was used as required to neutralize surface charging. The X-ray photoelectron spectroscopy (XPS) binding energy (BE) was internally referenced to the aliphatic C is peak at 284.6 eV. Survey spectra were acquired using an analyzer pass energy of 93.9 eV and a BE resolution of 0.8 eV, while high-resolution spectra were acquired with a pass energy of 23.5 eV and a BE resolution of 0.05 eV. The takeoff angle is defined as the angle between the surface and the photoelectron detector. Angle-dependent XPS (ADXPS) was performed by rotating the sample holder to the desired photoelectron takeoff angle. Spectra were deconvoluted using RBD software by fitting a series of Gaussian-Lorentzian functions to each chemically shifted photoelectron peak, after subtracting an appropriate background. Atomic concentrations were calculated by normalizing peak areas with the elemental sensitivity factor data in the PHI database. The thicknesses of polymer thin films were measured with a Beaglehole spectroscopic and imaging ellipsometer (Beaglehole Instruments, Wellington, New Zealand) under variable angle mode from 65° to 80° with a fixed wavelength of 632.8 nm. The final thickness data were averaged over multiple measurements (greater than five) taken at different locations on different samples. The measured ellipsometry data were analyzed using Film Wizard software using a Cauchy model. During the optimization to experiment, the thickness of the film was the only parameter adjusted. The optical constants used for the silicon wafer substrate were: n˜3.59-3.60, k˜0.015-0.025. The optical constants of the polymers were taken as their bulk values (PS=1.500, PtBA=1.456 and PMMA=1.489) and the thickness of the block copolymer was determined using an average refractive index, for example the refractive index for the PMMA+PtBA brushes was estimated to be 1.489^{PMMA}+1.456^{PtBA})/2=1.473. Optimization of the experiment was regarded as successful when the root-mean-squared error was less than 0.3 and the measured n and k of the polymer films as a function of the angle were in visual agreement with the simulation results.

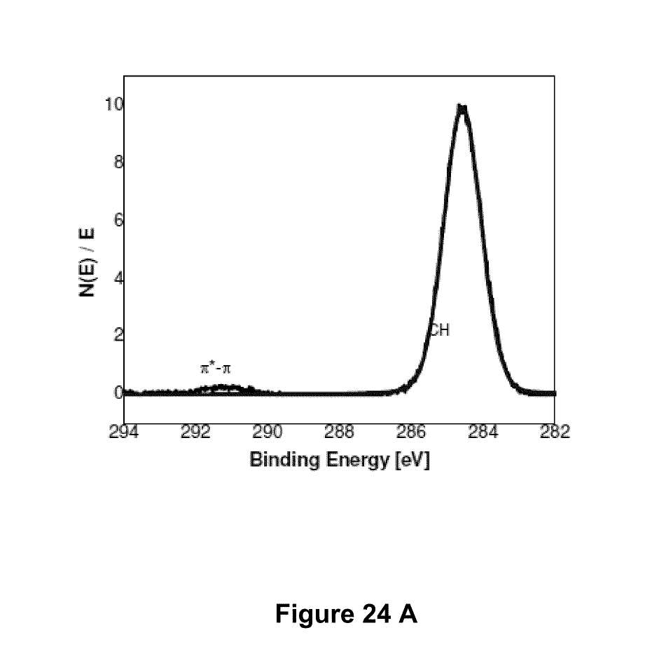

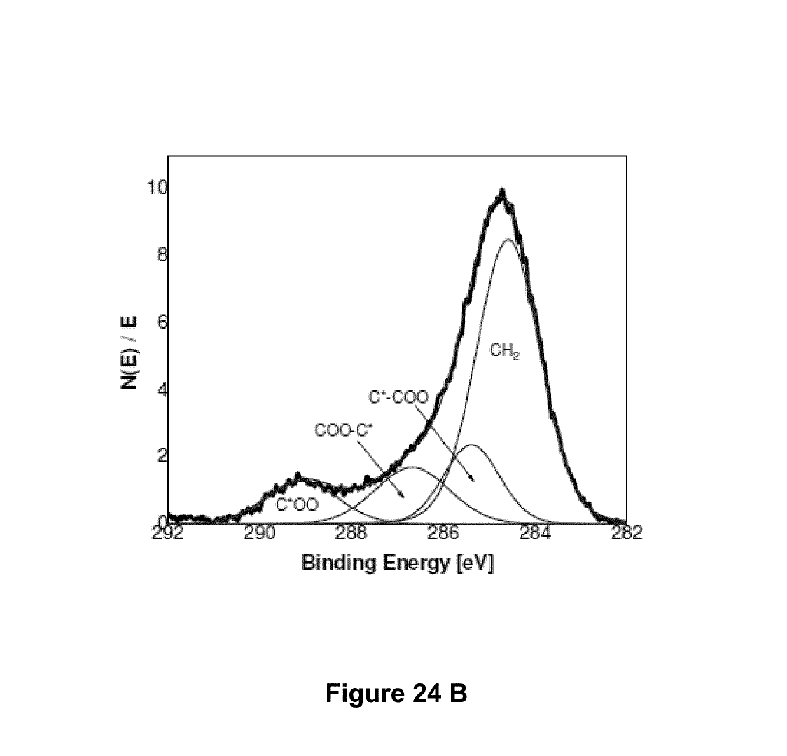

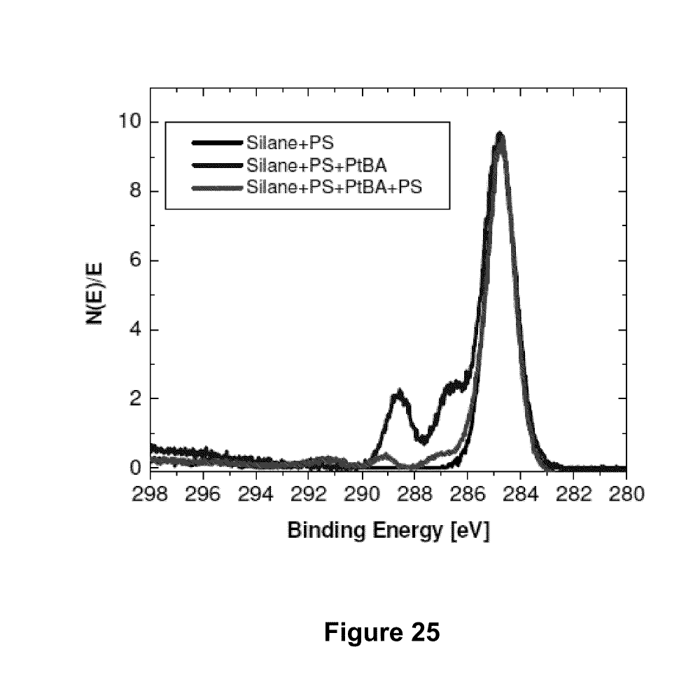

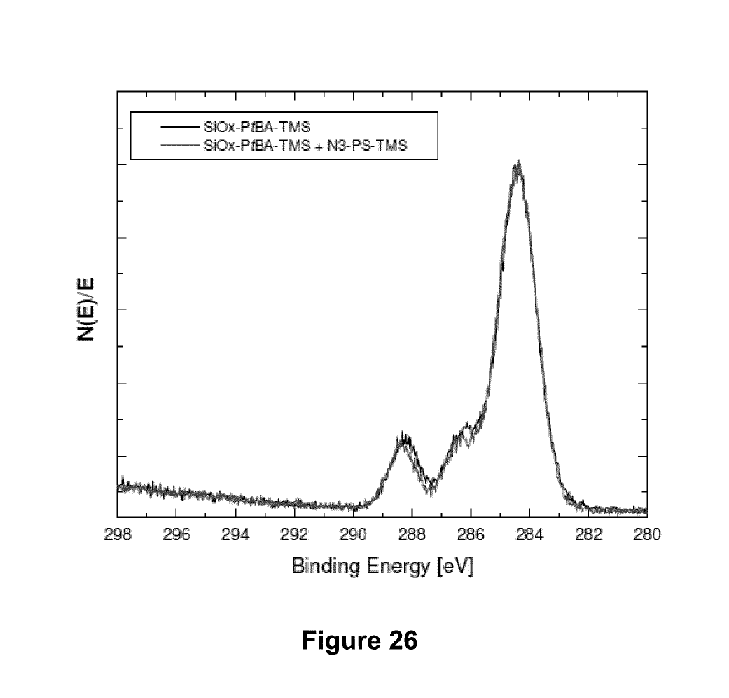

FIGS. 24-26 show the deconvolution results for the XPS high resolution C1s spectra of the layers before and after click chemistry, and for the control experiment showing the contribution of each carbon type. The measurements were done at take off angle (TOA) 15°. The functional PS brush substrate serves as the model substrate for subsequent click reactions with end-functional polymers.

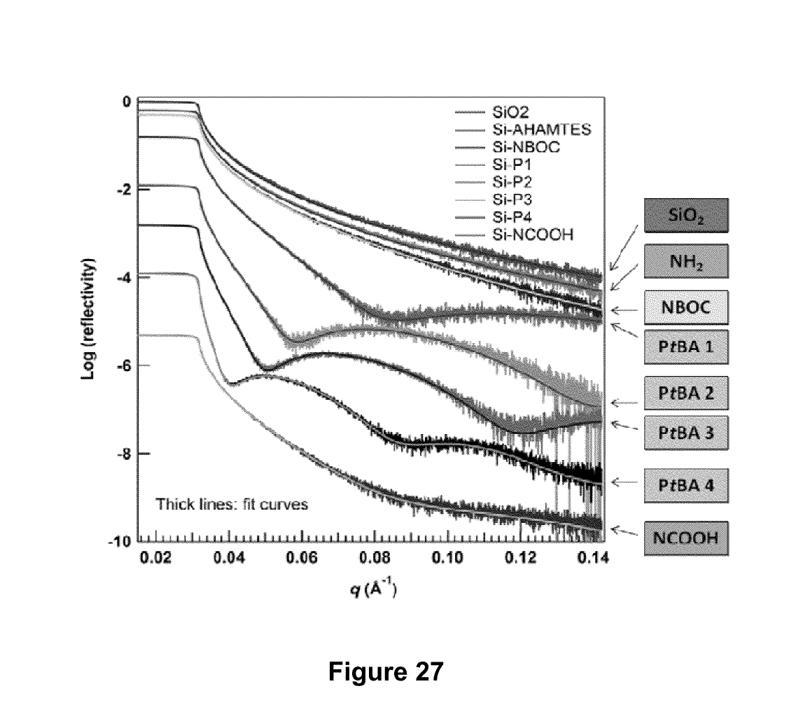

FIG. 27 shows x-ray reflectivity (XRR) curve and fit data of bare, amine, NBOC, 1 PtBA macromonomer, 2 PtBA macromonomers, 3 PtBA macromonomers, 4 PtBA macromonomers, and photocleaved substrates. The x-ray reflectometer used features a 4-bounce channel cut Ge[220] crystal monochromator in the incident beam, a 3-bounce Ge[220] crystal monochromator on the reflected beam, and goiniometers with an angular accuracy of ±0.0001°. These high precision elements are coupled with x-ray focusing optics to provide high resolution. With this configuration the thickness, density, and roughness of films and samples can be quantified to the nanometer scale. The momentum vector, q, indicates thickness and roughness based on the steepness and the amount of troughs in the curve.

Surface Control Experiment.

After making the first covalent polymer layer of SiOx-Silane-PS-TMS or SiOx-PtBA-TMS, a second layer of N₃-PtBA-TMS or N₃-PS-TMS was spin coated without deprotecting the first layer on the surface. No reaction was observed between the azide and the protected alkyne upon heating.

The initial step in SPS brush synthesis was to functionalize the substrate with alkyne groups. For glass and silicon wafers, this was accomplished by forming a self-assembled monolayer (SAM) (Chem. Rev. 1996, 96, 1553; Annu. Rev. Phys. Chem. 1992, 43, 437; J. Am. Chem. Soc. 1991, 113, 7152; Biomacromolecules 2005, 6, 2427; each herein incorporated by reference in its entirety) of an alkyne functional silane on the substrate surface. The thickness of the SAM, determined by angle-dependent X-ray photoelectron spectroscopy analysis, was 1.8±0.3 nm, while that measured by ellipsometry was 1.7±0.2 nm. From the structure of the silane, the thickness is expected to be about 1.1 nm. Similar silanes with 4-7 methylene units have a reported thickness of 1.5-2.3 nm (Surf Interfaces Anal. 1990, 15, 498; herein incorporated by reference in its entirety). The finding that these SAMs were thicker than expected is consistent with previous studies of other silanes that reported their polymerization to form multilayers (Mater. Sci. Eng. 2001, A302, 74; herein incorporated by reference in its entirety). The water contact angle of the alkyne-functionalized substrate was 61.8±1°, compared to <10±2° for the bare glass substrate, as expected for the more hydrophobic silane monolayer.

After functionalizing the substrate with alkyne groups, HetBi macromonomers were coupled to the surface by a click reaction between terminal azide groups of the macromonomers and surface alkynes. Each HetBi macromonomer was dissolved in toluene and spin-coated onto the surface, after which the coated substrates were placed in a vacuum oven and heated to 100-115° C. for 3-12 h to effect a thermally initiated “click” reaction (in the melt state) between substrate-bound alkyne groups and the azide termini of the polymers (J. Org. Chem. 2003, 68, 609; herein incorporated by reference in its entirety). After the reaction period, excess polymer was removed by extensive washing with solvent (DCM) for 1-24 h. Click reactions proceed to very high conversion under mild conditions with no side reactions or byproducts, and the resulting aromatic triazole is extremely stable (Russ. Chem. Rev. 2005, 74, 339; herein incorporated by reference in its entirety). In addition, click reactions are highly chemoselective such that virtually any polymer backbone may be used in the SPS process without interfering with the click reactions used to bond adjacent macromonomers.

The thermal stability of the TMS protecting groups was verified by a control experiment in which it was attempted to couple a macromonomer onto a polymer-modified surface that was not subject to the deprotection step. The thickness did not change when the deprotection step was omitted, indicating that no reaction occurred and that the TMS protecting groups are stable under the conditions used for the thermal click reaction.

Substrate bound alkyne groups were regenerated after macromonomer addition by deprotection of the terminal TMS-alkyne groups, accomplished by dipping the substrate into a K₂CO₃-saturated solution of 10:1 DCM/MeOH. The regenerated alkyne surface was then used to couple additional macromonomers by repeating the two-step addition cycle with other HetBi macromonomers.

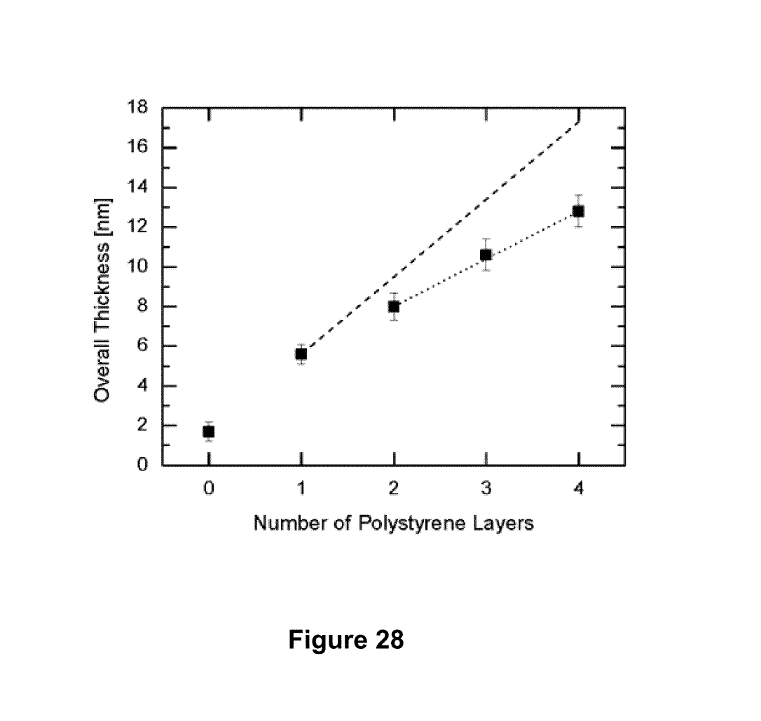

The first validation of the SPS method was homopolymacromer formation by multiple addition of TMS-alkyne-PSN₃. Successful sequential addition of multiple macromonomers is indicated by the thickness data in FIG. 28. When the first macromonomer is added to the alkyne-silane functionalized substrate, surface alkyne groups are in excess and a PS brush with a thickness of about 4 nm is formed. If each macromonomer is assumed to form a cube with the density of bulk PS (note, the coupling is performed in the melt), the expected thickness of a monomolecular layer would be about 3.24 nm. Polystyrene chains in the first layer therefore assume somewhat extended configurations, consistent with the results of previous studies of polystyrene brushes prepared by end-grafting from the melt (Macromolecules 2000, 33, 1043; herein incorporated by reference in its entirety). The thicknesses for the second through fourth addition cycles are linearly dependent on the number of macromonomers added, with each addition cycle adding about 2 nm to the overall film thickness. The fact that the thickness increase is the same for each macromonomer addition cycle is an important result because it suggests that the conversion of the interfacial click reactions is effectively complete for each macromonomer addition cycle. In other words, when a macromonomer adds to the growing brush on the substrate, the areal density of peripheral alkyne groups remains constant, each chain adding exactly one macromonomer in true step-growth fashion. If the conversion were less than complete, the areal density of alkyne groups and consequently the areal density and thickness of PS chains added would decrease each time a macromonomer was added. It is quite remarkable that complete conversion is apparently achieved for brushes prepared in a sequential “grafting to” fashion as is done herein. Certain attributes of the method are conducive to this result. First of all, the alkyne group is one of few reactive functional groups that has a low surface tension (estimated to be 26 mN/m by group contribution methods) and is therefore expected to segregate preferentially to the surface of most polymers (Macromolecules 1997, 30, 4481; herein incorporated by reference in its entirety). Second, the molecular weight of macromonomer added is identical in each cycle so that the occupied volume and functional group density of each are also the same. Third, because each cycle comprises the same PS macromonomer, there can be significant interpenetration between the brush and the macromonomer reacting to it. Interpenetration across the interface increases the effective volume for the reaction since complementary functional groups can only meet within the zone of interpenetration. Completion of the reaction for each layer can be verified by calculating the areal density of functional groups at the surface of the first PS layer and using this value to predict the thickness of subsequent layers. The areal density of functional groups for a tethered polymer brush layer can be calculated from the measured thickness, molecular weight, and density according to

Σ=ρAt/Mₙ (2)

where ρ, t, and Mₙ are the homopolymer density, thickness, and macromonomer molecular weight, respectively, and A is Avogadro's number. If the conversion is complete, the areal density of each layer will be the same, allowing for a prediction of the thickness, tᵢ, of any subsequent layer i from the relation

tᵢ=ΣMn,i/ρiA (3).

The dashed line in FIG. 28 shows the results of thickness predictions based upon the areal density after addition of the first PS macromonomer. As can be seen, the data fall below this line, indicating that the conversion for adding the second macromonomer is less than complete. This result arises from the fact that PS chains in the first macromonomer brush layer were found to be extended while chains in the spin-coated layer deposited to couple the second macromonomer are in an unperturbed melt. The lateral dimensions in the melt must exceed those of the extended polymer brush so that the areal density of azide groups in the spin-coated layer will be less than the areal density of alkyne groups in the initial brush layer. This situation alters the reaction stoichiometry so that complete conversion is not possible when the second macromonomer is coupled to the initial macromonomer brush. The dotted line in the figure shows the thickness predictions based upon the areal density achieved after addition of the second PS macromonomer. This prediction is in excellent agreement with the thickness of the third and fourth macromonomers, suggesting that complete conversion is achieved for all subsequent addition cycles after addition of the second macromonomer, a logical result because these reactions all involve coupling a macromonomer in the unperturbed melt state. Therefore, one can quantitatively predict the thickness change for subsequent macromonomer addition cycles from the known macromonomer molecular weight and the measured areal density of functional groups after addition of the second layer (determinable from a thickness measurement).

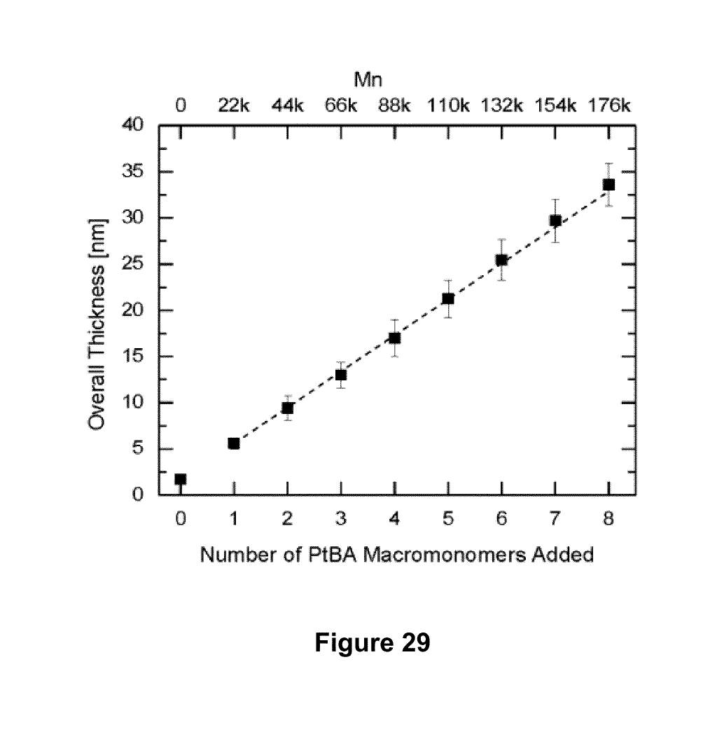

Thickness data for homopolymacromer brushes prepared by multiple SPS addition cycles of the TMS-alkyne-PtBA-N₃ macromonomer are shown in FIG. 29. The dashed line shows predictions assuming complete conversion based upon the areal density of the brush comprising one macromonomer. The thickness scales linearly with the number of macromonomer addition cycles up to 8 cycles and within error agrees with the predicted thickness for complete conversion (dashed line in figure), for all layers. If it is assumed that the increase in thickness is directly proportional to the conversion, a statistical analysis of the data provides a 95% confidence limit that the conversion for each addition falls within the range of 97.5-100%. Ellipsometry is of course an indirect measurement, and one would need to perform direct molecular weight measurements on cleaved polymers to validate this initial observation.

In contrast to the results for PS, the thickness added by coupling the first and second macromonomer is identical for the PtBA brushes. One difference between the two macromonomers can be found in their propensity to wet the substrate. The surface tension of PS is reported to be about 40 mN/m (J. Phys. Chem. 1970, 74, 632-638; herein incorporated by reference in its entirety), whereas the surface tension of PtBA is about 30 mN/m (Wu, S. Polymer Interface and Adhesion; Marcel Dekker: NewYork, 1982; herein incorporated by reference in its entirety). The tendency for the first PS layer to be somewhat extended may therefore be related to its difficulty to wet the substrate. PtBA, on the other hand, should readily wet the substrate so that the initial macromonomer brush formed can assume an unextended configuration after grafting, matching that in the reacting melt of the second macromonomer.

The accuracy of ellipsometric thickness data was validated by X-ray reflectivity (XR) measurements on PtBA brushes prepared independently on large silicon wafers using a slightly different alkyne silane as above. The ellipsometric and XR thickness data in Table 4 are in excellent agreement for four PtBA macromonomer addition cycles, illustrating the remarkable robustness, reproducibility, and quantitative nature of the SPS method for preparing homopolymacromer brushes. Details regarding the XR measurements are described above.

TABLE 4
Comparison of Thicknesses Determined by Ellipsometry and
X-Ray Reflectivity for PtBA Brushes Prepared by SPS on
Silicon Substrates.

Thickness (nm)

| PtBA macromonomers added | Ellipsometry | X-ray reflectivity |
|---|---|---|
| 1 | 5.5 | 5.4 |
| 2 | 7.5 | 7.7 |
| 3 | 9.5 | 9.6 |
| 4 | 11.5 | 11.9 |

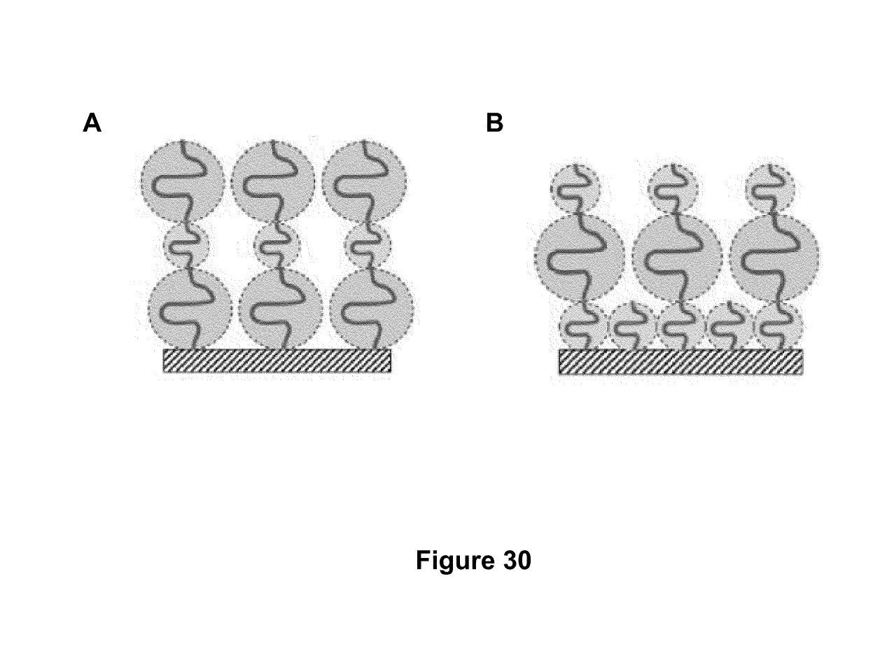

The solid phase synthesis of copolymacromer brushes was also investigated. In general, the linear thickness behavior observed for SPS of homopolymacromer brushes by multiple addition of the same macromonomer is not expected for brushes comprising different macromonomers or for that matter for brushes prepared from macromonomers of the same type but differing in molecular weight (i.e., molecular volume) Asymmetry in molecular weight (i.e., molecular volume) causes a mismatch in areal density of the two complementary functional groups that must react across the interface, as depicted in FIG. 30. For example, when a higher molecular molecular weight polymer, functional groups on the substrate (i.e., lower molecular weight layer) are in excess, and the higher molecular weight polymer can readily add. The conversion for functional groups on the substrate is less than complete, yet a full monolayer of the reacting macromonomer can form. However, if the inverse is true, that is, a higher molecular weight macromonomer is followed by a lower molecular weight macromonomer, functional groups on the substrate are the limiting reactants and functional groups on the lower molecular weight macromonomer to be added are in excess. In this latter case, a full monolayer of the lower molecular weight reacting macromonomer cannot form, but the conversion of surface functional groups can go to completion.

In most cases, a brush will be immiscible with a chemically distinct macromonomer that is added to it. The width of the interphase between immiscible polymers, which dictates the volume in which the interfacial reaction can occur, depends on the nature of thermodynamic interactions between the two different macromonomers (Phys. Today 1999, 52, 32; herein incorporated by reference in its entirety), and may influence the reaction conversion.

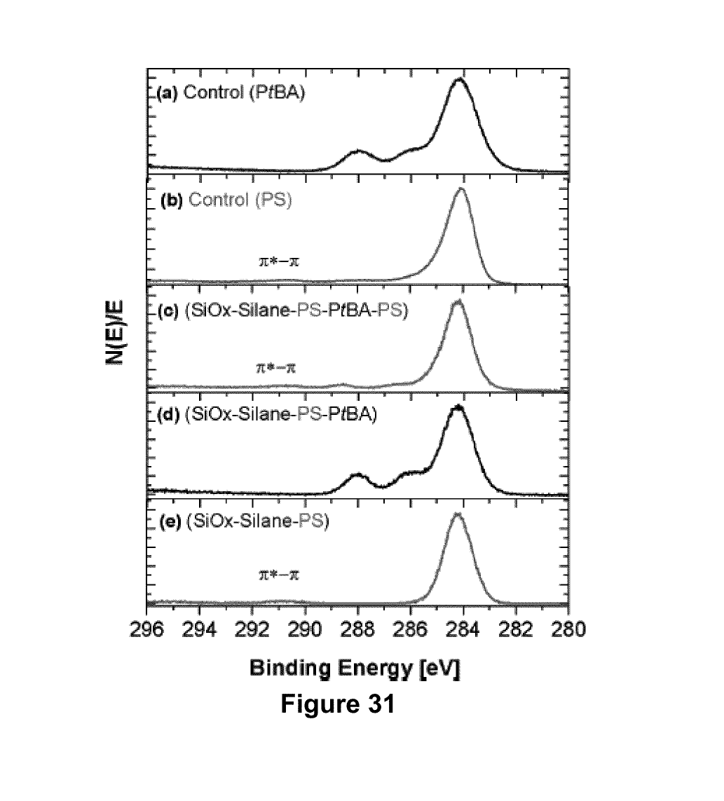

The effects of asymmetry in molecular size and chemical nature were studied for copolymacromer films prepared by alternating addition of TMS-alkyne-PS-N₃ and TMS-alkyne-PtBA-N₃. The deposition of each successive macromonomer was confirmed by contact angle, X-ray photoelectron spectroscopy (XPS), and ellipsometry measurements. The results of XPS characterization of the copolymacromer brushes are shown in FIG. 31. The photoelectrons detected have distinct binding energies associated with the atomic composition of the material being interrogated. The photoelectron spectra associated with carbon is orbitals are different for films of pure PtBA and PS due to chemical shifts induced by the presence of oxygen in the PtBA. The peak at 284.6 eV is the unshifted C is signal arising from carbon atoms bonded to only hydrogen or other carbon atoms. This signal is found in both the PS and PtBA control spectra. In PtBA, the signals associated with carbons bonded to oxygen undergo chemical shifts: the peak centered at 288.8 eV arises from the carbonyl carbon (O—C═O) in PtBA, and the peak near 287.2 eV originates from the ester carbon (C—O) in PtBA. The π*-π transition for pure PS is also apparent at ca. 291 eV. An O 1s signal from PtBA is also found at 531 eV (O 1s spectrum not shown).

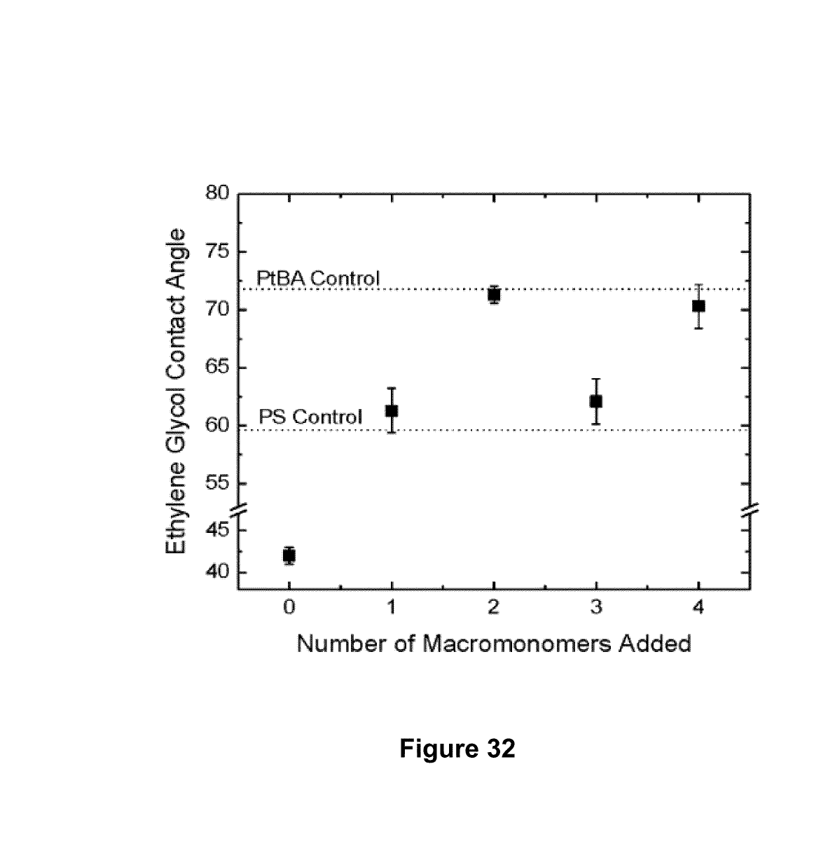

The spectrum for the substrate coated with a covalently bound PS brush (FIG. 31E) is identical to that of the pure PS control (FIG. 31B), including the π*-π shakeup satellite, confirming successful coupling of the PS macromonomer. After the PtBA macromonomer is added, the XPS spectrum (FIG. 31D) is found to closely resemble that of pure PtBA (FIG. 31A). When another PS macromonomer is added, the spectrum (FIG. 31c) reflects the presence of PS but also shows signals from PtBA. PtBA is detected in this case because the thickness of the deposited PS monomolecular layer is not thick enough to screen photoelectrons emanating from the underlying PtBA layer. The contact angle data shown in FIG. 32 confirm that copolymacromer brushes have been built up by successive addition of alternating TMS-alkyne-PS-N₃ and TMS-alkyne-PtBA-N₃ macromonomers. Brushes terminated with PtBA and PS macromonomers exhibit ethylene glycol contact angles that are similar to those of the corresponding homopolymer controls.

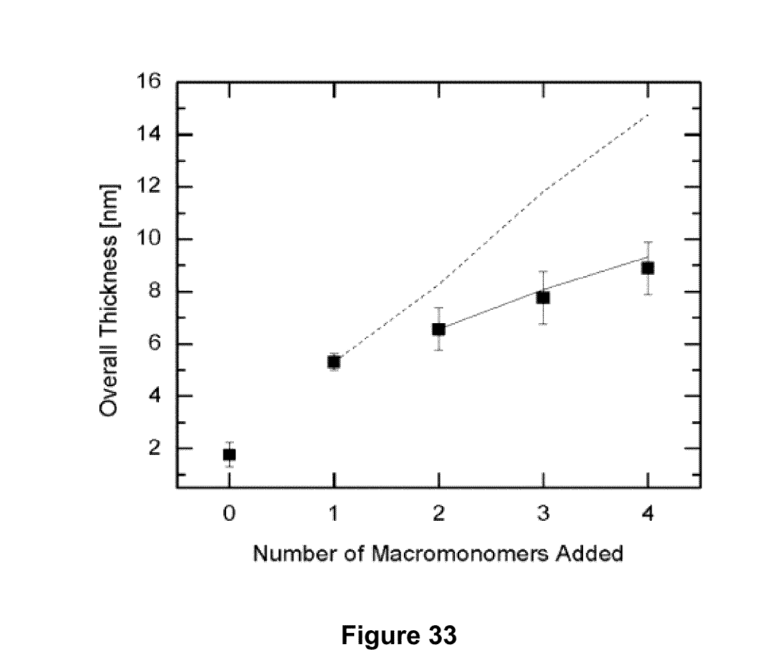

FIG. 33 presents thickness data for the PtBA-PS alternating copolymacromer brushes. Once the first brush layer is deposited onto the functional substrate, subsequent macromonomer additions yield a linear increase in thickness as the number of layers is increased. The resultant thin films are dense, segmented block copolymer brushes consisting of alternating sequences of PS and PtBA.

The dashed line in FIG. 33 shows the thicknesses predicted from the areal density of functional groups in the first PS brush based upon application of eqs 2 and 3; the solid line illustrates predictions based upon the areal density of functional groups after addition of the first PtBA macromonomer. As was seen for the PS homopolymacromer brushes, the conversion of the second layer is not complete, but one can predict the thicknesses of subsequent layers from the known molecular weight of the macromonomer and the areal density of the preceding layer. This observation indicates that after deposition of the second macromonomer the conversion of the interfacial reactions for subsequent macromonomer additions appears to be complete.

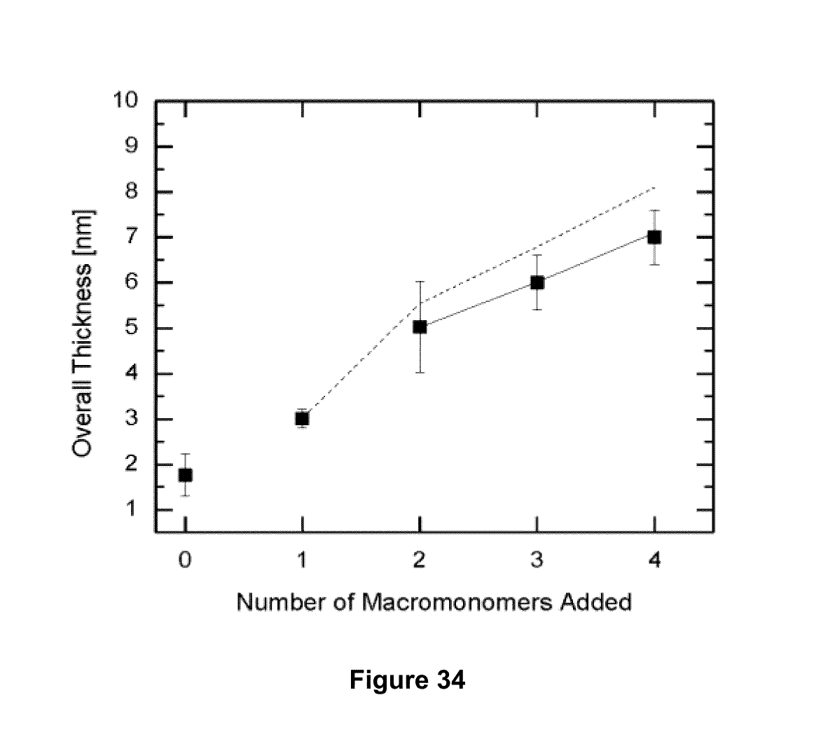

The ellipsometric thicknesses for alternating copolymacromer films of TMS-alkyne-PMMA-N₃ and TMS-alkyne-PS-N₃ are shown in FIG. 34. The same general behavior is again realized. Alternating macromonomers can be successfully added, but the conversion upon addition of the second macromonomer is again less than complete. The thickness of the brush comprising three macromonomers, however, can again be predicted quantitatively from the known polymer molecular weight and the areal density of the preceding brush comprising two macromonomers calculated according to eqs 2 and 3, assuming that the interfacial reaction goes to completion.

What is claimed is:

1. A method for generating a multilayer polymacromer composition, the method comprising:
(a) functionalizing a substrate with a primer surface group to form a functionalized substrate layer,
(b) covalently linking a linker to the primer surface group, wherein the linker comprises a photocleavable functionality and a click moiety terminus,
(c) forming a monomolecular layer by contacting the click moiety terminus of the linker with a first heterobifunctional macromolecule comprising a polymer backbone, a first click moiety terminus and a protected second click moiety terminus,
(d) deprotecting the protected second click moiety terminus to form a functionalized monomolecular layer and,
(e) forming a second monomolecular layer by contacting the functionalized monomolecular layer with a second heterobifunctional macromolecule comprising a polymer backbone, a first click moiety terminus and a protected second click moiety terminus, or a first heterotrifunctional branch comprising a first click moiety group and at least two protected second click moiety groups.

2. The method of claim 1, further comprising the step of repeating steps (c) to (e) until a multilayer polymacromer composition comprising (i) a primer surface layer comprising a linker, wherein the linker comprises a photocleavable functionality, (ii) a monomolecular layer comprising a heterobifunctional macromolecule, and (iii) a desired number of monomolecular layers between the linker and a surface monomolecular layer is obtained.

3. The method of claim 1, further comprising removal of the multilayer polymacromer composition from the substrate, wherein removal is achieved by irradiation of the photocleavable functionality.

4. The method of claim 3, wherein the polymacromer is not destroyed.

5. The method of claim 3, wherein greater than about 50% of the multilayer polymacromer composition is removed.

6. The method of claim 3, wherein greater than about 90% of the multilayer polymacromer composition is removed.

7. The method of claim 3, wherein greater than about 95% of the multilayer polymacromer composition is removed.

8. The method of claim 1, wherein efficiency of monomolecular layer formation is greater than about 50%.

9. The method of claim 1, wherein efficiency of monomolecular layer formation is greater than about 90%.

10. The method of claim 1, wherein efficiency of monomolecular layer formation is greater than about 95%.

11. The method of claim 1, wherein the first click moieties are alkyne groups or azide groups.

12. The method of claim 1, wherein the substrate comprises a ceramic, a crystal, a silicon, a metal oxide, a metal alloy, gold, quartz, indium tin oxide, antimony tin oxide, a semiconductor, a semiconductor alloy or any combination thereof.

13. The method of claim 1, wherein the substrate is comprises SiO₂.

14. The method of claim 1, wherein the heterobifunctional macromolecule is comprised of a polymer, a blend of polymers, a polymer precursor, a thermoplastic polymer, or a thermosetting polymer.

15. The method of claim 1, wherein the heterobifunctional macromolecule is comprised of a α-silyl alkyne-poly(styrene)-N₃, α-silyl alkyne-poly(tert-butyl acrylate)-N₃, or α-silyl alkyne-poly(methyl methacrylate)-N₃.

16. The method of claim 1, wherein the heterobifunctional macromolecule is comprised of a α-trimethylsilyl alkynyl-ω-azido-poly(styrene), α-trimethylsilyl alkynyl-ω-azido-poly(tert-butyl acrylate), α-trimethylsilyl alkynyl-ω-azido-poly(methyl methacrylate).

17. The method of claim 1, wherein the heterobifunctional macromolecule is from about 10 Daltons to about 2,000,000 Daltons.

18. The method of claim 1, wherein the substrate is a comprises glass.

19. The method of claim 1 wherein the primer surface group comprises an amino group.

20. The method of claim 1, wherein the photocleavable functionality comprises a nitro-benzyloxycarbonyl group.

21. The method of claim 1, wherein the photocleavable functionality comprises a nitro-benzyloxycarbamate group.

22. A method for generating a multilayer polymacromer composition, the method comprising:
(a) functionalizing a substrate with a primer surface group, wherein the primer comprises a silicon and an amine group, to form a functionalized substrate layer,
(b) covalently linking a linker to the primer surface group, wherein the linker comprises a nitrobenzyloxy carbonyl functionality and a click moiety terminus,
(c) forming a monomolecular layer by contacting the click moiety terminus of the linker with a first heterobifunctional macromolecule comprising a α-trimethylsilyl alkynyl-ω-azido-poly(tert-butyl acrylate),
(d) deprotecting the α-trimethylsilyl alkynyl terminus to form a functionalized monomolecular layer and,
(e) forming a second monomolecular layer by contacting the alkyne terminus of the first monomolecular layer with a second heterobifunctional macromolecule comprising a α-trimethylsilyl alkynyl-ω-azido-poly(tert-butyl acrylate).

23. The method of claim 22, further comprising the step of repeating steps (c) to (e) until a multilayer polymacromer composition comprising a desired number of monomolecular layers between the linker and a surface monomolecular layer is obtained.

24. The method of claim 22, further comprising removal of the multilayer polymacromer composition from the substrate, wherein removal is achieved by irradiation of the nitrobenzyloxy carbonyl functionality.

25. A multilayer polymacromer composition comprising:
(a) a first terminus comprising a nitrophenyl functionality, and
(b) n-layers, wherein each layer comprises a poly(tert-butyl acrylate) macromolecule, and wherein n is an integer between 1 and 100.

26. The composition of claim 25, wherein the macromolecule layers are linked to each other by a triazole.

27. The composition claim 25, further comprising one or more branches between one or more macromolecular layers, wherein the branches are bound to the macromolecules by a triazole.
